(19) United States
(12) Patent Application Publication
(10) Pub. No.: US 2016/0320914 A1
(43) Pub. Date: Nov. 3, 2016

(54) INPUT DEVICE AND METHOD FOR CONTROLLING INPUT DEVICE

(71) Applicant: FUJIKURA LTD., Tokyo (JP)

(72) Inventors: Yasuyuki TACHIKAWA, Sakura-shi (JP); Makoto TAKAMATSU, Sakura-shi (JP); Osamu AOKI, Sakura-shi (JP); Toshiaki WATANABE, Sakura-shi (JP)

(73) Assignee: FUJIKURA LTD., Tokyo (JP)

(21) Appl. No.: 15/108,113

(22) PCT Filed: Dec. 25, 2014
(86) PCT No.: PCT/JP2014/084295

§ 371 Date: Jun. 24, 2016

(30) Foreign Application Priority Data
Dec. 27, 2013 (JP) 2013-272968

(51) Int. Cl. G06F 3/041; G06F 3/045

(52) U.S. Cl. CPC G06F 3/0418; G06F 3/0414; G06F 3/045; G06F 2203/04105

(57) ABSTRACT

An input device 1 includes a pressure-sensitive sensor 50 and a sensor controller 90. The sensor controller 90 includes an acquisition part 91 which obtains an actual output value of the pressure-sensitive sensor 50, a storage part 92 in which a correction function g(Vₒᵤₜ) is stored, and a correction part 93 which substitutes the actual output value into the correction function g(Vₒᵤₜ) so as to correct the actual output value for linearizing output characteristics of the pressure-sensitive sensor 50. The correction function g(Vₒᵤₜ) is a function which is obtained by replacing an output variable Vₒᵤₜ of the pressure-sensitive sensor 50 with a corrected output variable Vₒᵤₜ′ of the pressure-sensitive sensor 50 and also replacing an applied-load variable F to the pressure-sensitive sensor 50 with the output variable Vₒᵤₜ in an inverse function f⁻¹(F) of the output characteristic function f(F) of the pressure-sensitive sensor 50.

### TECHNICAL FIELD

The present invention relates to an input device including a pressure-sensitive sensor and a method for controlling the input device.

For designated countries which permit the incorporation by reference, the contents described and/or illustrated in the documents relevant to Japanese Patent Application No. 2013-272968 filed on Dec. 27, 2013 will be incorporated herein by reference as a part of the description and/or drawings of the present application.

### BACKGROUND ART

For improvement of detection accuracy of a pressure-sensitive sensor, the following is known as a technique for reducing variation in pressure-sensitive sensor characteristics between individuals.

Namely, there are known a technique to determine an approximate expression representing a relationship between output and pressure for each pressure-sensitive sensor on the basis of an actual measured data (for example, refer to Patent Document 1) and a technique to determine standardized information of external force-resistance characteristics in which a resistance value of a pressure-sensitive sensor is considered to be 0 when an external force is 0 and the resistance value of the pressure-sensitive sensor to be 1 when an external force is at its maximum (for example, refer to Patent Document 2).

### PRIOR ART DOCUMENT

### Patent Document

[Patent Document 1] JP2005-106513 A

[Patent Document 2] JP2011-133421 A

### SUMMARY OF INVENTION

### Problems to be Solved by Invention

However, in the first place, a pressure-sensitive sensor has characteristics in a form of a curve where a rate of decrease in resistance values is duller as an applied load is larger. Accordingly, even when load-variation amounts are the same, a phenomenon that resistance variation amounts are different from each other depending on an initial load occurs. For this reason, unless characteristics of the sensitive sensor are linearized, there is a problem that detection accuracy of the pressure-sensitive sensor cannot be sufficiently improved.

An object of the present invention is to provide an input device and a method for controlling the input device capable of improving detection accuracy of a pressure-sensitive sensor by linearizing characteristics of the pressure-sensitive sensor.

### Means for Solving Problems

[1] An input device according to the present invention is an input device comprising: a pressure-sensitive sensor whose output changes in accordance with a pressing force; and a controller to which a pressure-sensitive sensor is electrically connected. The controller includes: an acquisition part which obtains an actual output value of the pressure-sensitive sensor; a storage part in which a correction function g(Vₒᵤₜ) is stored; and a correction part which substitutes the actual output value into the correction function g(Vₒᵤₜ) so as to correct the actual output value for linearizing an output characteristic of the pressure-sensitive sensor. The correction function g(Vₒᵤₜ) is a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ.

[2] In the invention, a resistance value of the pressure-sensitive sensor may continuously change in accordance with the pressing force.

[3] An input device according to the present invention is an input device comprising: a pressure-sensitive sensor whose resistance value continuously changes in accordance with the pressing force; and a controller to which the pressure-sensitive sensor is electrically connected. The controller includes: an acquisition part which obtains an actual output value of the pressure-sensitive sensor; a storage part in which a correction function g(Vₒᵤₜ) is stored; and a correction part which substitutes the actual output value into the correction function g(Vₒᵤₜ) so as to correct the actual output value. The correction function g(Vₒᵤₜ) is a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ. The acquisition part includes a fixed resistor which is electrically connected in series to the pressure-sensitive sensor. The output characteristic function f(F) is the following expression (1).

$$\begin{matrix}[ Expression 1 ] & \\ f ( F ) = {V}_{out} = {V}_{i n} \frac{{R}_{fix}}{{R}_{fix} + h ( F )} & ( 1 )\end{matrix}$$

In the expression (1), Vᵢₙ is an input-voltage value to the pressure-sensitive sensor, R_{fix} is a resistance value of the fixed resistor, and h(F) is a resistance characteristic function which represents a relationship between the applied-load variable F and a resistance variable of the pressure-sensitive sensor.

[4] In the invention, the resistance characteristic function h(F) may be the following expression (2), and the correction function g(Vₒᵤₜ) may be the following expression (3).

$$\begin{matrix}[ Expression 2 ] & \\ h ( F ) = k \times {F}^{- n} & ( 2 ) \\ [ Expression 3 ] & \\ g ( {V}_{out} ) = {V}_{out}^{′} = {\{ \frac{{R}_{fix}}{k} ( \frac{{V}_{i n}}{{V}_{out}} - 1 ) \}}^{\frac{1}{n}} & ( 3 )\end{matrix}$$

In the expression (2) and expression (3), “k” is an intercept constant of the pressure-sensitive sensor, and “n” is an inclination constant of the pressure-sensitive sensor.

[5] In the invention, “n” may be equal to 1 (n=1) in the expression (3).

[6] An input device according to the present invention is an input device comprising: a pressure-sensitive sensor whose output continuously changes in accordance with the pressing force; and a controller to which the pressure-sensitive sensor is electrically connected. The controller includes: an acquisition part which obtains an actual output value of the pressure-sensitive sensor; a storage part in which a correction function g(Vₒᵤₜ) is stored; and a correction part which substitutes the actual output value into the correction function g(Vₒᵤₜ) so as to correct the actual output value for linearizing an output characteristic of the pressure-sensitive sensor. The correction function g(Vₒᵤₜ) is an approximate function which is approximate to a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ.

An input device according to the present invention is an input device comprising: a pressure-sensitive sensor whose output continuously changes in accordance with a pressing force; and a controller to which the pressure-sensitive sensor is electrically connected. The controller includes: an acquisition part which obtain an actual output value of the pressure-sensitive-sensor; a storage part in which a correction function g(Vₒᵤₜ) is stored; and a correction part which substitutes the actual output value into the correction function g(Vₒᵤₜ) so as to correct the actual output value. The correction function g(Vₒᵤₜ) is an approximate function which is approximate to a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ. The correction function g(Vₒᵤₜ) is the following expression (4).

[Expression 4]

g(Vₒᵤₜ)=Vₒᵤₜ′=a×Vₒᵤₜ² (4)

In the expression (4), “a” is a proportional constant of the pressure-sensitive sensor.

[8] In the invention, the input device may comprise a plurality of pressure-sensitive sensors each of which is the pressure-sensitive sensor, a plurality of correction functions g(Vₒᵤₜ) each of which is the correction function g(Vₒᵤₜ) may be respectively stored in storage parts each of which is the storage part, and the correction functions g(Vₒᵤₜ) may individually correspond to the pressure-sensitive sensors.

[9] In the invention, the input device further may comprise a panel unit which includes at least a panel unit, and the pressure-sensitive sensor may detect a load applied through the panel unit.

[10] In the invention, the pressure-sensitive sensor may include: a first substrate; a second substrate which is opposite to the first substrate; a first electrode which is provided on the first substrate; a second electrode which is provided on the second substrate so as to be opposite to the first electrode; and a spacer which is interposed between the first substrate and the second substrate and which has a through-hole at a position which corresponds to the first electrode and the second electrode.

[11] A method for controlling an input device according to the present invention is a method for controlling an input device including a pressure-sensitive sensor whose output continuously changes in accordance with a pressing force. The method includes: a first step for preparing a correction function g(Vₒᵤₜ); a second step for obtaining an actual output value of the pressure-sensitive sensor; and a third step for substituting the actual output value into the correction function g(Vₒᵤₜ) so as to correct the actual output value for linearizing an output characteristic of the pressure-sensitive sensor. The correction function g(Vₒᵤₜ) is a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ.

[12] In the invention, a resistance value of the pressure-sensitive sensor may continuously change in accordance with the pressing force.

[13] A method for controlling an input device according to the present invention is a method for controlling an input device including a pressure-sensitive sensor whose resistance value continuously changes in accordance with a pressing force. The method includes: a first step for preparing a correction function g(Vₒᵤₜ); a second step for obtaining an actual output value of the pressure-sensitive sensor; and a third step for substituting the actual output value into the correction function g(Vₒᵤₜ) so as to correct the actual output value. The correction function g(Vₒᵤₜ) is a function which is obtained by replacing an output value Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ. The input device includes a fixed resistor which is electrically connected in series to the pressure-sensitive sensor, and the output characteristic function f(F) is the following expression (5).

$$\begin{matrix}[ Expression 5 ] & \\ f ( F ) = {V}_{out} = {V}_{i n} \frac{{R}_{fix}}{{R}_{fix} + h ( F )} & ( 5 )\end{matrix}$$

In the expression (5), Vᵢₙ is an input-voltage value to the pressure-sensitive sensor, R_{fix} is a resistance value of the fixed resistor, h(F) is a resistance characteristic function which represents a relationship between the applied-load variable F and the resistance variable of the pressure-sensitive sensor.

[14] In the invention, the resistance characteristic function h(F) may be the following expression (6), and the correction function g(Vₒᵤₜ) may be the following expression (7).

$$\begin{matrix}[ Expression 6 ] & \\ h ( F ) = k \times {F}^{- n} & ( 6 ) \\ [ Expression 7 ] & \\ g ( {V}_{out} ) = {V}_{out}^{′} = {\{ \frac{{R}_{fix }}{k} ( \frac{{V}_{in}}{{V}_{out}} - 1 ) \}}^{- \frac{1}{n}} & ( 7 )\end{matrix}$$

In the expression (6) and expression (7), “k” is an intercept constant of the pressure-sensitive sensor, and “n” is an inclination constant of the pressure-sensitive sensor.

[15] In the invention, “n” may be equal to 1 (n=1) in the expression (7).

[16] A method for controlling an input device according to the present invention is a method for controlling an input device including a pressure-sensitive sensor whose output continuously changes in accordance with a pressing force. The method includes: a first step for preparing a correction function g(Vₒᵤₜ); a second step for obtaining an actual output value of the pressure-sensitive sensor; and a third step for substituting the actual output value into the correction function g(Vₒᵤₜ) so as to correct the actual output value for linearizing an output characteristic of the pressure-sensitive sensor. The correction function g(Vₒᵤₜ) is an approximate function which is approximate to a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ.

[17] A method for controlling an input device according to the present invention is a method for controlling an input device including a pressure-sensitive sensor whose output continuously changes in accordance with a pressing force. The method includes: a first step for preparing a correction function g(Vₒᵤₜ); a second step for obtaining an actual output value of the pressure-sensitive sensor; and a third step for substituting the actual output value into the correction function g(Vₒᵤₜ) so as to correct the actual output value. The correction function g(Vₒᵤₜ) is an approximate function which is approximate to a function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor. The output characteristic function f(F) is a function which represents a relationship between the applied-load variable F and the output variable Vₒᵤₜ of the pressure-sensitive sensor. The inverse function f⁻¹(F) is an inverse function of the output characteristic function f(F) for the applied-load variable F and the output variable Vₒᵤₜ. The correction function g(Vₒᵤₜ) is the following expression (8).

[Expression 8]

g(Vₒᵤₜ)=Vₒᵤₜ′=a×Vₒᵤₜ² (8)

In the expression (8), “a” is a proportional constant of the pressure-sensitive sensor.

[18] In the invention, the input device may include a plurality of pressure-sensitive sensors each of which is the pressure-sensitive sensor, the first step may include preparing a plurality of the correction functions g(Vₒᵤₜ) each of which is the correction function g(Vₒᵤₜ), and the correction functions g(Vₒᵤₜ) may individually correspond to the pressure-sensitive sensors.

[19] In the invention, the pressure-sensitive sensor may include: a first substrate; a second substrate which is opposite to the first substrate; a first electrode which is provided on the first substrate; a second electrode which is provided on the second substrate so as to be opposite to the first electrode; and a spacer which is interposed between the first substrate and the second substrate and which has a through-hole at a position which corresponds to the first electrode and the second electrode.

### Effect of Invention

According to the present invention, the actual output value is corrected by substituting an actual output value into a correction function g(Vₒᵤₜ) which is obtained by replacing an output variable Vₒᵤₜ with a corrected output variable Vₒᵤₜ′ and also replacing an applied-load variable F with the output variable Vₒᵤₜ in an inverse function f⁻¹(F) of an output characteristic function f(F) of a pressure-sensitive sensor. In this way, output characteristics of the pressure-sensitive sensor can be linearized, and thus detection accuracy of the pressure-sensitive sensor can be improved.

According to the present invention, the actual output value is corrected by substituting an actual output value into a correction function g(Vₒᵤₜ) which is approximate to a function which is obtained by replacing an output variable Vₒᵤₜ with a corrected output variable Vₒᵤₜ′ and also replacing an applied-load variable F with the output variable Vₒᵤₜ in an inverse function f⁻¹(F) of an output characteristic function f(F) of a pressure-sensitive sensor. In this way, output characteristics of the pressure-sensitive sensor can be linearized, and thus detection accuracy of the pressure-sensitive sensor can be improved.

### BRIEF DESCRIPTION OF DRAWINGS

FIG. 1 is a plan view of an input device in the embodiment of the present invention.

FIG. 2 is a cross-sectional view taken along line II-II in FIG. 1.

FIG. 3 is an exploded perspective view of a touch panel in the embodiment of the present invention.

FIG. 4 is a cross-sectional view of a pressure-sensitive sensor in the embodiment of the present invention.

FIG. 5 is an enlarged cross-sectional view showing a modification of the pressure sensitive sensor in the embodiment of the present invention.

FIG. 6 is a plan view of a display device in the embodiment of the present invention.

FIG. 7 is a block diagram showing a system configuration of the input device in the embodiment of the present invention.

FIG. 8(a) is a circuit diagram showing detailed configuration of an acquisition part in FIG. 7, and FIG. 8(b) is an equivalent circuit diagram of the acquisition part.

FIG. 9 is a circuit diagram showing a first modification of the acquisition part in the embodiment of the present invention.

FIG. 10 is a circuit diagram showing a second modification of the acquisition part in the embodiment of the present invention.

FIG. 11 is a graph showing load-resistance characteristics (a resistance characteristic function h(F)) of a pressure-sensitive sensor in the embodiment of the present invention.

FIG. 12 is a graph showing load-output voltage characteristics (an output characteristic function f(F)) of a pressure-sensitive sensor in the embodiment of the present invention.

FIG. 13 is a graph showing an output characteristic function f(F), an inverse function f⁻¹(F), and corrected output values derived from a correction function g(Vₒᵤₜ)

FIG. 14(a) is a graph showing output characteristics of pressure-sensitive sensors before correction, and FIG. 14(b) is a graph showing output characteristics of the pressure-sensitive sensors after correction.

FIG. 15 is a graph showing output characteristics of the pressure-sensitive sensors after correction using a first approximate function.

FIG. 16 is a graph showing output characteristics of the pressure-sensitive sensors after correction using a second approximate function.

FIG. 17 is a flow chart showing a method for controlling an input device in the embodiment of the present invention.

FIG. 18(a) and FIG. 18(b) are graphs to explain advantageous effects in detail in the embodiment of the present invention. FIG. 18(a) shows output characteristics of pressure-sensitive sensors before correction, and FIG. 18(b) shows the output characteristics of the pressure-sensitive sensors after correction.

### MODES FOR CARRYING OUT THE INVENTION

Hereinafter, an embodiment of the present invention will be described with reference to the accompanying drawings.

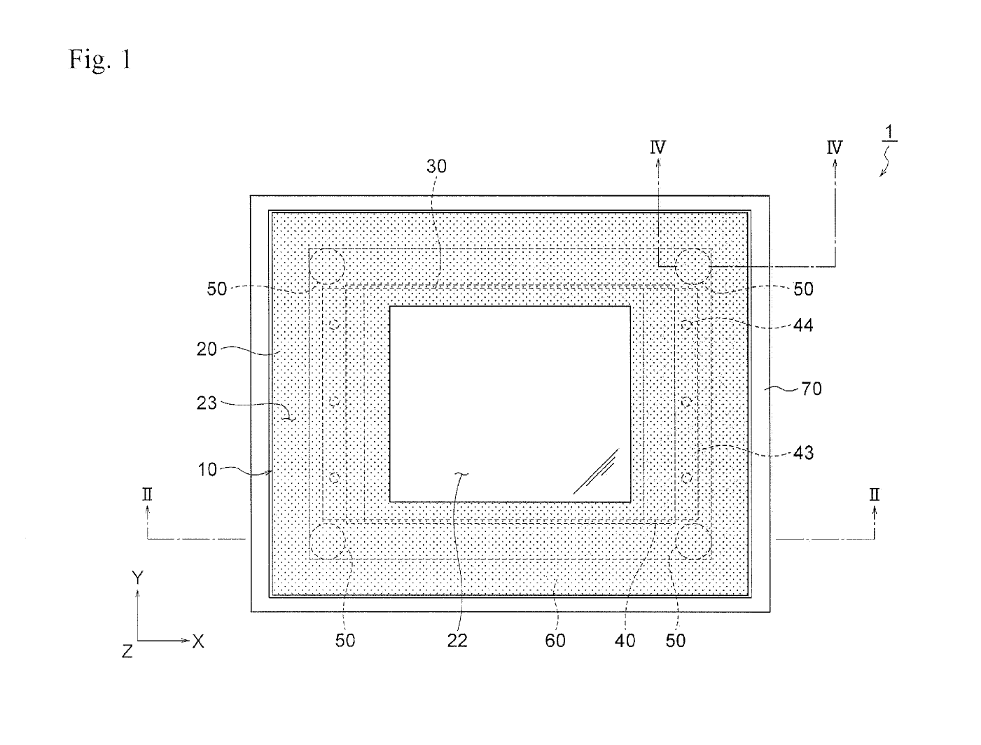

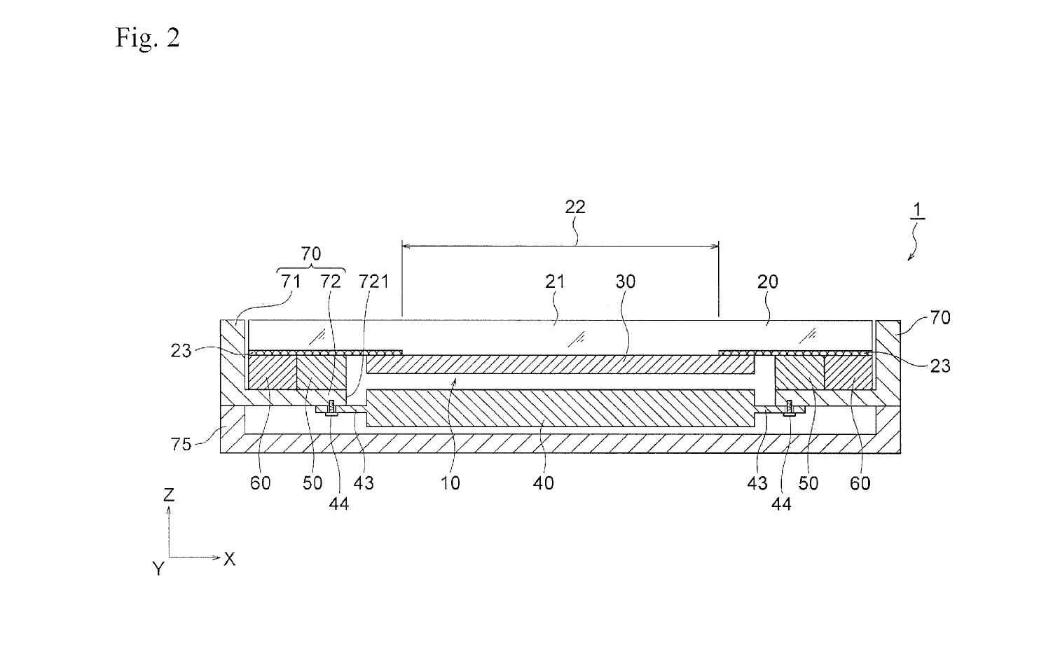

FIG. 1 is a plan view and FIG. 2 is a cross-sectional view of an input device in the embodiment of the present invention. The configuration of the input device 1 described in the following is only one example, and the configuration is not particularly limited thereto.

As illustrated in FIG. 1 and FIG. 2, an input device (an electronic apparatus) in the present embodiment includes a panel unit 10, a display device 40, pressure-sensitive sensors 50, a seal member 60, a first support member 70, and a second support member 75. The panel unit 10 includes a cover member 20 and a touch panel 30. The panel unit 10 is supported by the first support member 70 through the pressure-sensitive sensors 50 and the seal member 60, and a minute vertical movement of the panel unit 10 with respect to the first support member 70 is permitted due to the elastic deformations of the pressure-sensitive sensors 50 and the seal member 60.

The input device 1 can display an image with the display device 40 (display function). In addition, in a case where an arbitrary position on the display is indicated by a finger of an operator, a touch pen, or the like, the input device 1 can detect X and Y coordinates of the position with the touch panel 30 (position input function). Further, in a case where the panel unit 10 is pressed in the Z-direction with a finger of the operator or the like, the input device 1 can detect the pressing operation with the pressure-sensitive sensors 50 (pressing detection function).

As illustrated in FIG. 1 and FIG. 2, the cover member 20 is constituted by a transparent substrate 21 through which visible light beams can be transmitted. Specific examples of such material from which the transparent substrate 21 is made include glass, polymethylmethacrylate (PMMA), polycarbonate (PC), and the like.

A shielding portion (bezel portion) 23, for example, which is formed by applying white ink, black ink, or the like, is provided on a lower surface of the transparent substrate 21. The shielding portion 23 is formed in a frame shape in a region on the lower surface of the transparent substrate 21 except for a rectangular transparent portion 22 which is located at the center of the lower surface.

The shapes of the transparent portion 22 and the shielding portion 23 are not particularly limited to the above-described shapes. A decorating member which is decorated with a white color or a black color may be laminated on a lower surface of the transparent substrate 21 so as to form the shielding portion 23. Alternatively, a transparent sheet, which has substantially the same size as the transparent substrate 21 and in which only a portion corresponding to the shielding portion 23 is colored with a white color or a black color, may be prepared, and the sheet may be laminated on the lower surface of the transparent substrate 21 so as to form the shielding portion 23.

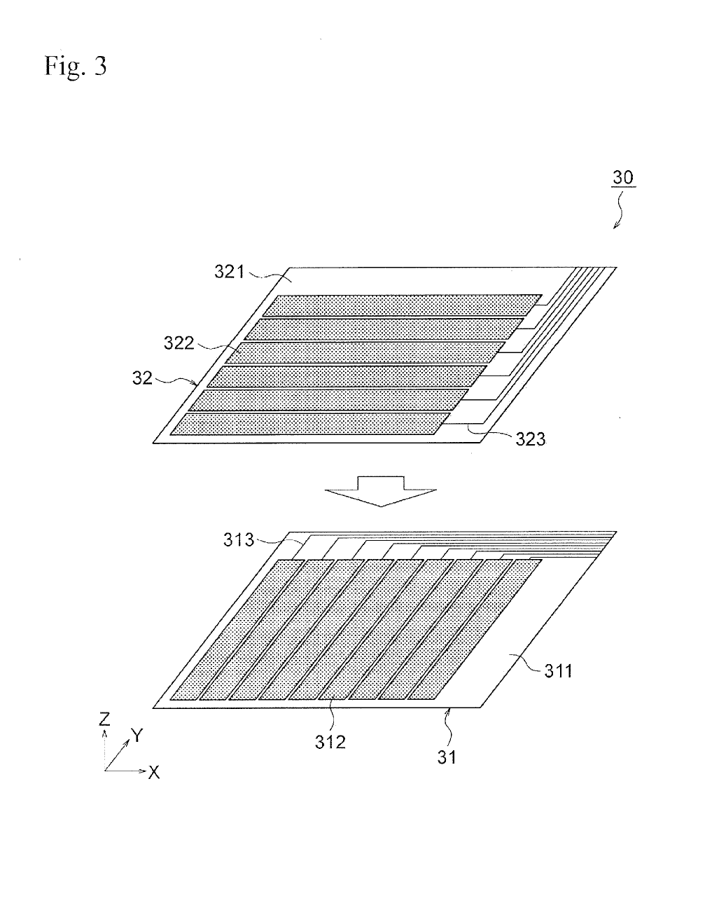

FIG. 3 is an exploded perspective view of a touch panel in the present embodiment.

As illustrated in FIG. 3, the touch panel 30 is an electrostatic capacitance type touch panel including two electrode sheets 31 and 32 which overlap each other.

The structure of the touch panel is not particularly limited thereto, and for example, a resistive-film-type touch panel or an electromagnetic-induction-type touch panel may be employed. The below-described electrode patterns 312 and 322 may be formed on the lower surface of the cover member 20, and the cover member 20 may be used as a part of the touch panel. Alternatively, a touch panel prepared by forming an electrode on both surfaces of a sheet may be used instead of the two electrode sheets 31 and 32.

The first electrode sheet 31 includes a first transparent base material (substrate) 311 through which visible light beams can be transmitted, and first electrode patterns 312 which are provided on the first transparent base material 311.

Specific examples of a material of which the first transparent base material 311 is made include resin materials such as polyethylene terephthalate (PET), polyethylene naphthalate (PEN), polyethylene (PE), polypropylene (PP), polystyrene (PS), an ethylene-vinyl acetate copolymer resin (EVA), vinyl resin, polycarbonate (PC), polyamide (PA), polyimide (PI), polyvinyl alcohol (PVA), an acrylic resin, and triacetyl cellulose (TAC), and glass.

For example, the first electrode patterns 312 are transparent electrodes which are made of indium tin oxide (ITO) or a conductive polymer, and are configured as strip-like face patterns (so-called solid patterns) which extend in the Y-direction in FIG. 3. In an example illustrated in FIG. 3, nine first electrode patterns 312 are arranged in parallel on the first transparent base material 311. The shape, the number, the arrangement, and the like of the first electrode patterns 312 are not particularly limited to the above-described configurations.

In the case where the first electrode patterns 312 are made of ITO, for example, the first electrode patterns 312 are formed through sputtering, photolithography, and etching. On the other hand, in the case where the first electrode patterns 312 are made of a conductive polymer, the first electrode patterns 312 can be formed through sputtering or the like similar to the case of ITO, or can be formed through a printing method such as screen printing and gravure-offset printing, or through etching after coating.

Specific examples of the conductive polymer of which the first electrode patterns 312 are made include organic compounds such as a polythiophene-based compound, a polypyrrole-based compound, a polyaniline-based compound, a polyacetylene-based compound, and a polyphenylene-based compound. A PEDOT/PSS compound is preferably used among these compounds.

The first electrode patterns 312 may be formed by printing conductive paste on the first transparent base material 311 and by curing the conductive paste. In this case, each of the first electrode patterns 312 is formed in a mesh shape instead of the face pattern so as to secure sufficient light transmittance of the touch panel 30. As the conductive paste, for example, conductive paste obtained by mixing metal particles such as silver (Ag) or copper (Cu) with a binder such as polyester or polyphenol can be used.

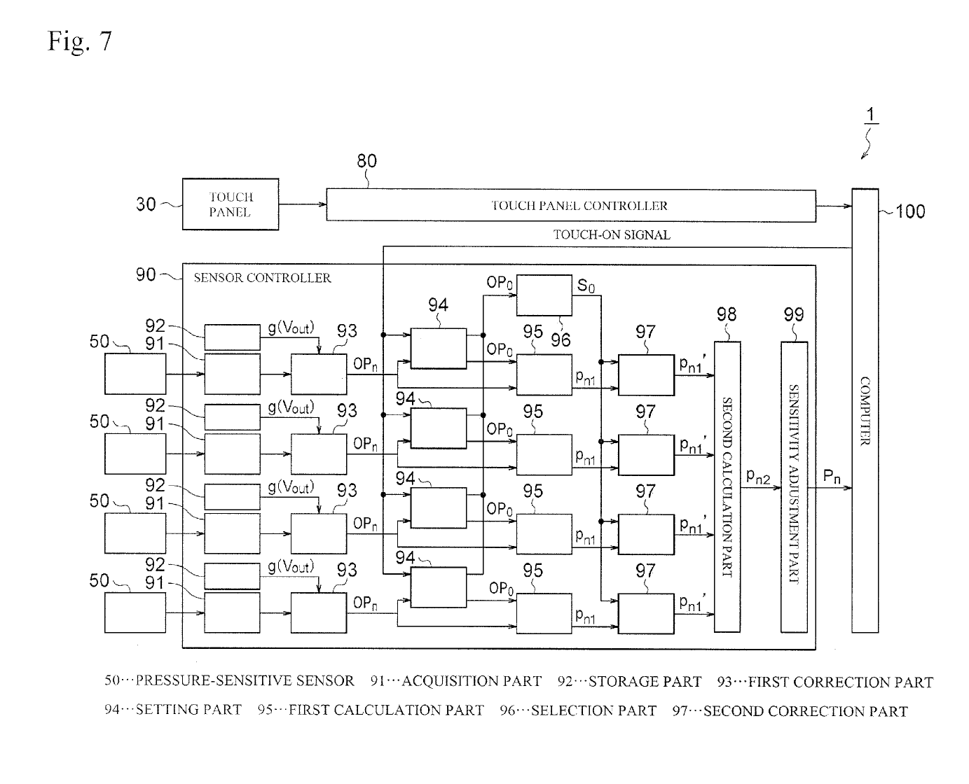

The first electrode patterns 312 are connected to a touch panel controller 80 (refer to FIG. 7) through a first lead-out wiring pattern 313. The first lead-out wiring pattern 313 is provided at a position, which faces the shielding portion 23 of the cover member 20, on the first transparent base material 311, and the first lead-out wiring pattern 313 is not visually recognized by the operator. Therefore, the first lead-out wiring pattern 313 is formed by printing conductive paste on the first transparent base material 311 and by curing the conductive paste.

The second electrode sheet 32 also includes a second transparent base material (substrate) 321 through which visible light beams can be transmitted, and second electrode patterns 322 which are provided on the second transparent base material 321.

The second transparent base material 321 is made of the same material as in the above-described first transparent base material 311. Similar to the above-described first electrode patterns 312, the second electrode patterns 322 are also transparent electrodes which are made of, for example, indium tin oxide (ITO) or a conductive polymer.

The second electrode patterns 322 are configured as strip-like face patterns which extend in the X-direction in FIG. 3. In an example illustrated in FIG. 3, six second electrode patterns 322 are arranged in parallel on the second transparent base material 321. The shape, the number, the arrangement, and the like of the second electrode patterns 322 are not particularly limited to the above-described configurations.

The second electrode patterns 322 are connected to the touch panel controller 80 (refer to FIG. 7) through a second lead-out wiring pattern 323. The second lead-out wiring pattern 323 is provided at a position, which faces the shielding portion 23 of the cover member 20, on the second transparent base material 321, and the second lead-out wiring pattern 323 is not visually recognized by the operator. Therefore, similar to the above-described first lead-out wiring pattern 313, the second lead-out wiring pattern 323 is also formed by printing conductive paste on the second transparent base material 321 and by curing the conductive paste.

The first electrode sheet 31 and the second electrode sheet 32 are attached to each other through a transparent gluing agent in such a manner that the first electrode patterns 312 and the second electrode patterns 322 are substantially orthogonal to each other in a plan view. The touch panel 30 itself is attached to the lower surface of the cover member 20 through the transparent gluing agent in such a manner that the first and second electrode patterns 312 and 322 face the transparent portion 22 of the cover member 20. Specific examples of the transparent gluing agent include an acryl-based gluing agent, and the like.

The panel unit 10 including the above-described cover member 20 and touch panel 30 is supported by the first support member 70 through the pressure-sensitive sensors 50 and the seal member 60 as shown in FIG. 2. As shown in FIG. 1, the pressure-sensitive sensors 50 are arranged at the four corners of the panel unit 10 in the present embodiment. On the other hand, the seal member 60, which has a rectangular annular shape, is disposed outside the pressure-sensitive sensors 50 and arranged over the entire circumference of the panel unit 10 along the outer edge of the panel unit 10. The pressure-sensitive sensors 50 and the seal member 60 are each attached to the lower surface of the cover member 20 through a gluing agent and also to the first support member 70 through the gluing agent. The number and the arrangement of the pressure-sensitive sensors 50 are not particularly limited as long as the pressure-sensitive sensors 50 can stably hold the panel unit 10.

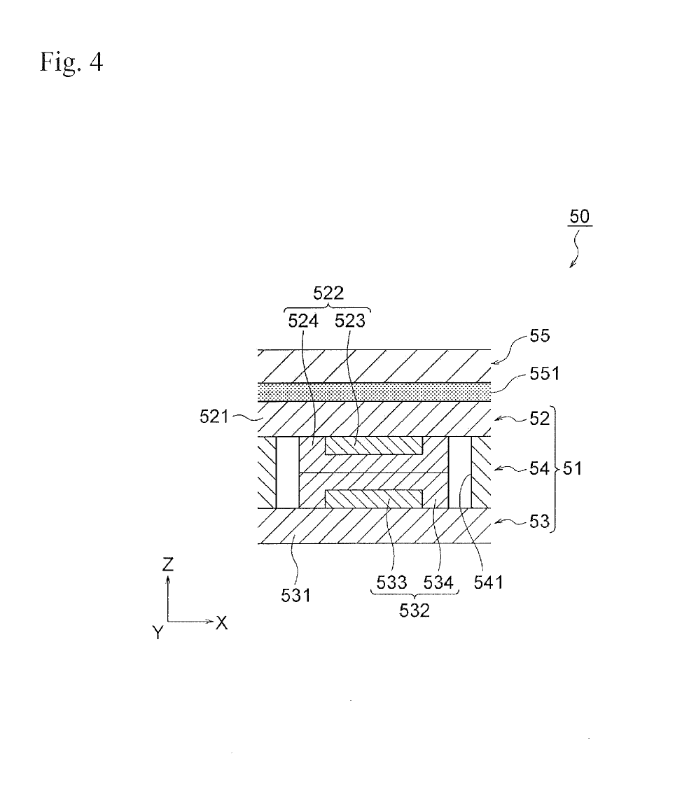

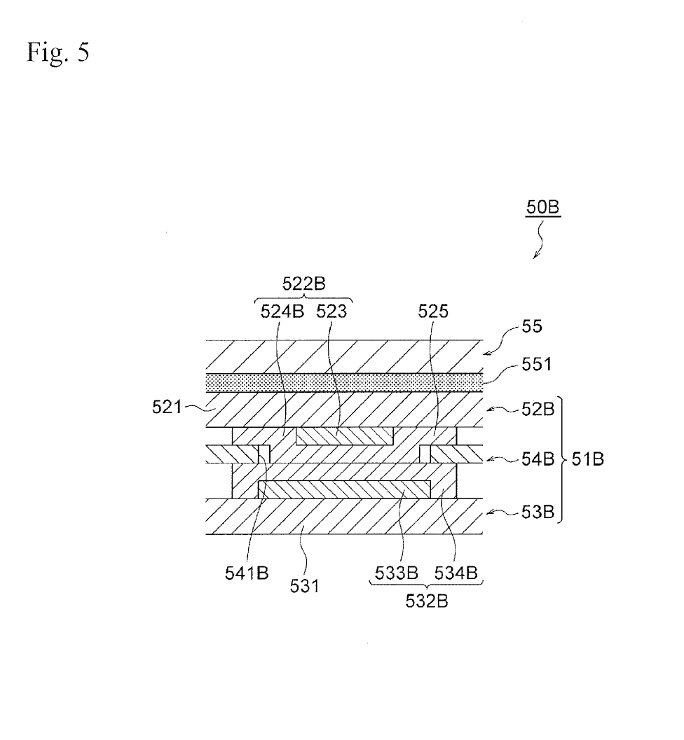

FIG. 4 is a cross-sectional view of a pressure-sensitive sensor in the present embodiment, and FIG. 5 is an enlarged cross-sectional view showing a modification of the pressure-sensitive sensor in the present embodiment.

As illustrated in FIG. 4, each of the pressure-sensitive sensors 50 includes a detecting part 51 and an elastic member 55. The detecting part 51 includes a first electrode sheet 52, a second electrode sheet 53, and a spacer 54 interposed therebetween. FIG. 4 is a cross-sectional view taken along line IV-IV in FIG. 1.

The first electrode sheet 52 includes a first base material (substrate) 521 and an upper electrode 522. The first base material 521 is a flexible insulating film, and is made of, for example, polyethylene terephthalate (PET), polyethylene naphthalate (PEN), polyimide (PI), polyetherimide (PEI), or the like.

The upper electrode 522 includes a first upper electrode layer 523 and a second upper electrode layer 524, and is provided on a lower surface of the first base material 521. The first upper electrode layer 523 is formed by printing conductive paste, which has a relatively low electric resistance, on the lower surface of the first base material 521, and by curing the conductive paste. On the other hand, the second upper electrode layer 524 is formed by printing conductive paste, which has a relatively high electric resistance, on the lower surface of the first base material 521 so as to cover the first upper electrode layer 523, and by curing the conductive paste.

The second electrode sheet 53 also includes a second base material (substrate) 531 and a lower electrode 532. The second base material 531 is made of the same material as in the above-described first base material 521. The lower electrode 532 includes a first lower electrode layer 533 and a second lower electrode layer 534, and is provided on an upper surface of the second base material 531.

Similar to the above-described first upper electrode layer 523, the first lower electrode layer 533 is formed by printing conductive paste, which has a relatively low electric resistance, on an upper surface of the second base material 531, and by curing the conductive paste. On the other hand, similar to the above-described second upper electrode layer 524, the second lower electrode layer 534 is formed by printing conductive paste, which has a relatively high electric resistance, on the upper surface of the second base material 531 so as to cover the first lower electrode layer 533, and by curing the conductive paste.

Examples of conductive paste, which has a relatively low electric resistance, include silver (Ag) paste, gold (Au) paste, and copper (Cu) paste. In contrast, examples of conductive paste, which has a relatively high electric resistance, include carbon (C) paste. Examples of a method for printing the conductive paste include screen printing, gravure-offset printing, an inkjet method, and the like.

The first electrode sheet 52 and the second electrode sheet 53 are laminated through a spacer 54. The spacer 54 includes a double-sided adhesive sheet, and its base material is made of an insulating material such as polyethylene terephthalate (PET), polyethylene naphthalate (PEN), polyimide (PI), polyetherimide (PEI), or the like. The spacer 54 is attached to the first electrode sheet 52 and the second electrode sheet 53 through adhesive layers arranged on its both surfaces.

A through-hole 541 is formed in the spacer 54 at a position which corresponds to the upper electrode 522 and the lower electrode 532. The upper electrode 522 and the lower electrode 532 are located inside the through-hole 541 and are faced each other. The thickness of the spacer 54 is adjusted so that the upper electrode 522 and the lower electrode 532 come into contact with each other in a state where no pressure is applied to the pressure-sensitive sensor 50.

In a non-load state, the upper electrode 522 and the lower electrode 532 may not be in contact with each other. However, when the upper electrode 522 and the lower electrode 532 are brought into contact with each other in advance in a non-load state, a problem, in which the electrodes do not contact with each other even when a pressure is applied (that is, an output of the pressure-sensitive sensor 50 is zero (0)), does not occur, and detection accuracy of the pressure-sensitive sensor 50 can be improved.

In a state in which a predetermined voltage is applied between the upper electrode 522 and the lower electrode 532, when a load from the upper side is applied to the pressure-sensitive sensor 50, a degree of adhesion between the upper electrode 522 and the lower electrode 532 increases in accordance with the magnitude of the load, and electric resistance between the electrodes 522 and 532 decreases. On the other hand, when the load to the pressure-sensitive sensor 50 is released, a degree of adhesion between the upper electrode 522 and the lower electrode 532 decreases, and electric resistance between the electrodes 522 and 532 increases.

Accordingly, the pressure-sensitive sensor 50 is capable of detecting the magnitude of the pressure applied to the pressure-sensitive sensor 50 on the basis of the resistivity change. The input device 1 in the present embodiment detects a pressing operation by an operator to the panel unit 10 by comparing an electric resistance value of the pressure-sensitive sensor 50 with a predetermined threshold value. In the present embodiment, “an increase in the degree of adhesion” means an increase in a microscopic contact area, and “a decrease in the degree of adhesion” means a decrease in the microscopic contact area.

The second upper electrode layer 524 or the second lower electrode layer 534 may be formed by printing pressure-sensitive ink instead of the carbon paste, and by curing the pressure-sensitive ink. For example, a specific example of the pressure-sensitive ink includes a quantum tunnel composite material which utilizes a quantum tunnel effect. Another example of the pressure-sensitive ink includes, for example, pressure-sensitive ink containing conductive particles of metal, carbon or the like, elastic particles of an organic elastic filler, inorganic oxide filler or the like, and a binder. The surface of the pressure-sensitive ink is uneven due to elastic particles. The electrode layers 523, 524, 533, and 534 can be formed through a plating process or a patterning process instead of the printing method. In a plan view, when a distance from the center of the panel unit to each of the pressure-sensitive sensors varies, sensitivity of the sensitive sensor closer to the center of the panel unit may be lowered. Specifically, a resistance value of a first fixed resistor 912 described later may be decreased or the pressure-sensitive sensor may be made not to bend easily so as to lower sensitivity of the pressure-sensitive sensor.

An elastic member 55 is laid on the first electrode sheet 52 through a gluing agent 551. The elastic member 55 is made from an elastic material such as a foaming material or rubber material. Specific examples of the foaming material forming the elastic member 55 include, for example, a urethane foam, a polyethylene foam, and a silicone foam each of which has closed cells. Further, examples of the rubber material forming the elastic member 55 include a polyurethane rubber, a polystyrene rubber, and a silicone rubber. The elastic member 55 may be laid under the second electrode sheet 53. Alternatively, the elastic members 55 may be laid on the first electrode sheet 52 and also under the second electrode sheet 53.

By providing the elastic member 55 to the pressure-sensitive sensor 50, the load applied to the pressure-sensitive sensor 50 can be dispersed evenly throughout the detecting part 51, and detection accuracy of the pressure-sensitive sensor 50 can be improved. When the support member 70, 75, or the like is distorted or when the tolerance of the support member 70, 75, or the like in the thickness direction is large, the distortion and tolerance can be absorbed by the elastic member 55. When excess pressure or shock is applied to the pressure-sensitive sensor 50, damage or destruction of the pressure-sensitive sensor 50 can also be prevented with the elastic member 55.

The structure of the pressure-sensitive sensor is not particularly limited to the above. For example, as in a pressure-sensitive sensor 50B shown in FIG. 5, an annular protruding part 525 may be formed with a second upper electrode layer 524B of an upper electrode 522B, a lower electrode 532B may be expanded so as to make its diameter the same as the protruding part 525, and a spacer 54B may be formed so as to be sandwiched between the protruding part 525 and the lower electrode 532B. The protruding part 525 in the present embodiment protrudes radially from the upper part of the upper electrode 522B. Further, the inner diameter of a through-hole 541B of the spacer 54B in the present embodiment is relatively smaller than the outer diameter of the protruding part 525 of the upper electrode 522B and the outer diameter of the lower electrode 532B.

As long as a relationship between the applied load and the pressure-sensitive sensor is nonlinearity, the structure of the pressure-sensitive sensor is not particularly limited to the above. For example, a piezoelectric element or strain gauge may be used as the pressure-sensitive sensor. Alternatively, Micro Electro Mechanical Systems (MEMS) element of a cantilevered shape (or a both-ends supported shape) having a piezo-resistance layer may be used as the pressure-sensitive sensor. Alternatively, a pressure sensor having a structure of sandwiching polyamino acid material having piezoelectricity between insulating substrates each having formed with an electrode by screen printing may be used as the pressure-sensitive sensor. Alternatively, a piezoelectric element utilizing polyvinylidene fluoride (PVDF) having piezoelectricity may be used as the pressure-sensitive sensor. Alternatively, the one detecting an applied load on the basis of a variation in electrostatic capacitance between a pair of electrodes may be used as the pressure-sensitive sensor, or the one using a conductive rubber may also be used as the pressure-sensitive sensor.

As with the above elastic member 55, a seal member 60 is also made of an elastic material such as a foaming material, rubber material or the like. Specific examples of the foaming material forming the seal member include, for example, a urethane foam, a polyethylene foam, a silicone foam, and the like each of which has closed cells. Further, examples of the rubber material forming the seal member 60 include a polyurethane rubber, a polystyrene rubber, a silicone rubber, and the like. By placing such seal member 60 between a cover member 20 and the first support member 70, inclusion of foreign substances from the outside can be prevented.

Preferably, the elasticity modulus of the elastic member 55 is respectively higher than the elasticity modulus of the seal member 60. In this way, pressing force can be accurately transmitted to the pressure-sensitive sensor 50, and detection accuracy of the pressure-sensitive sensor 50 can be improved.

As shown in FIG. 2, the pressure-sensitive sensors 50 and the seal member 60 described above are sandwiched between the cover member 20 and the first support member 70. The first support member 70 includes a frame part 71 and a holder 72. The frame part 71 has a rectangular frame shape with an opening capable of housing the cover member 20. On the other hand, the holder 72 has a rectangular annular shape and is radially protruded to the inside from the lower end of the frame part 71. The pressure sensitive sensors 50 and the seal member 60 are supported by the support member 72 so as to be interposed between the cover member 20 and the first support member 70. The first support member 70 is made of, for example, a metal material such as aluminum or the like, or a resin material such as polycarbonate (PC), ABS resin, or the like. The frame part 71 and the holder 72 are integrally formed.

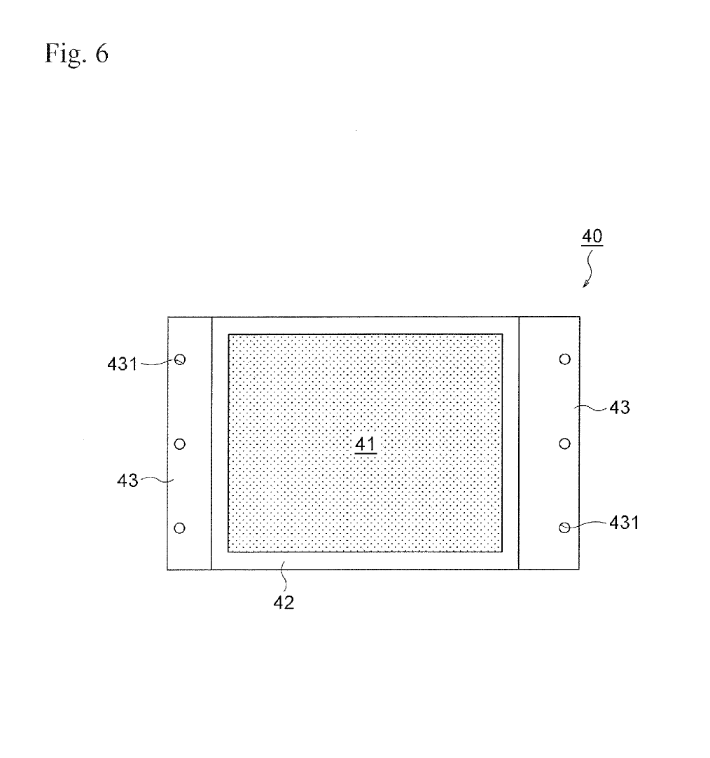

FIG. 6 is a plan view of a display device in the present embodiment.

As illustrated in FIG. 6, the display device 40 includes a display region 41 on which an image is displayed, an outer edge region 42 which surrounds the display region 41, and a flange 43 which protrudes from both ends of the outer edge region 42. For example, the display region 41 of the display device 40 is constitutes by a thin-type display device such as a liquid crystal display, an organic EL display, or an electronic paper.

A through-hole 431 is formed on the flange 43. The through-hole 431 faces a screw hole formed on the rear surface of the first support member 70. As shown in FIG. 2, when a screw 44 is screwed into the screw hole of the first support member 70 through the through-hole 431, the display device 40 is fixed to the first support member 70. Accordingly, the display region 41 faces a transparent portion 22 of the cover member 20 through a center opening 721 of the first support member 70.

Like the first support member 70 described above, the second support member 75 is made of, for example, a metal material such as aluminum or the like, or a resin material such as polycarbonate (PC), ABS resin, or the like. The second support member 75 is attached to the first support member 70 through a gluing agent so as to cover the rear surface of the display device 40. Instead of the gluing agent, the second support member 75 may be fastened with a screw to the first support member 70.

In the following, a system configuration of the input device 1 in the present embodiment is explained with reference to FIG. 7 to FIG. 10.

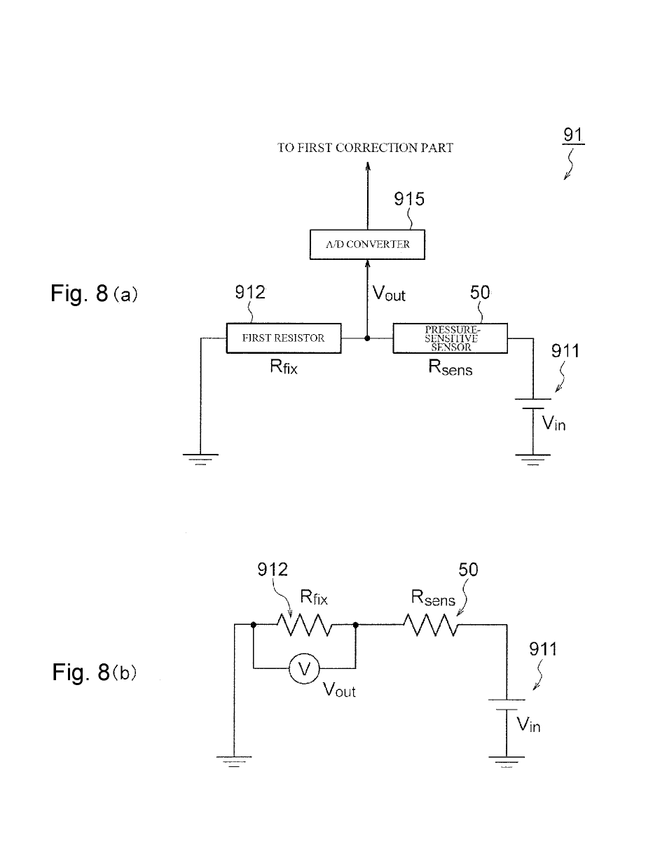

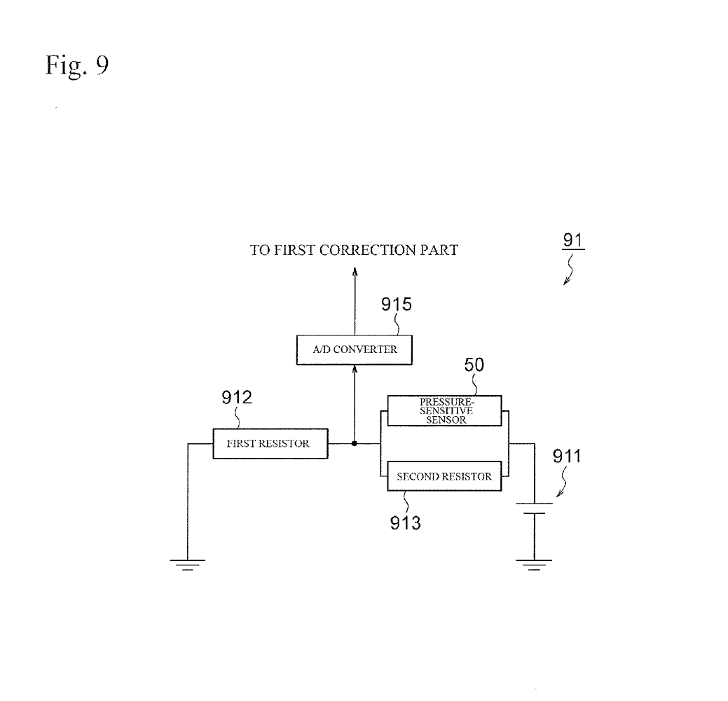

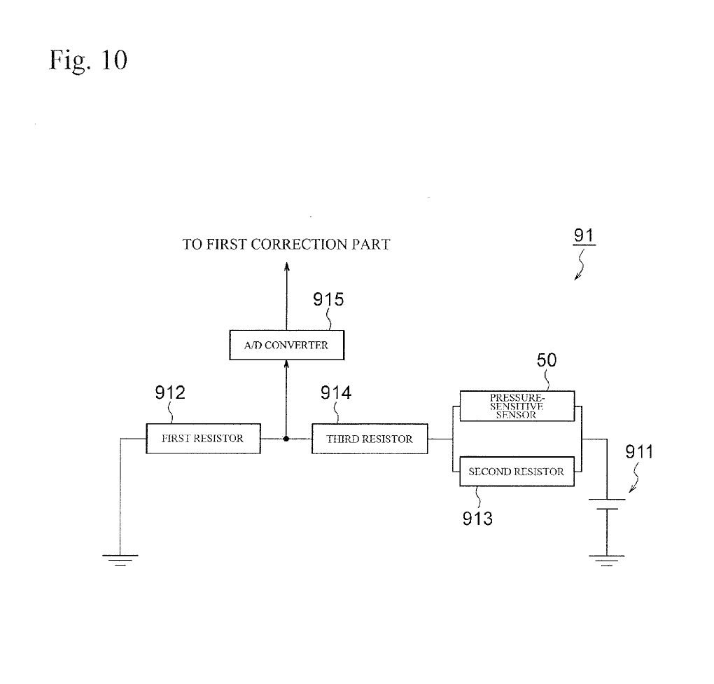

FIG. 7 is a block diagram showing a system configuration of the input device in the present embodiment. FIG. 8(a) is a circuit diagram showing details of the acquisition part in FIG. 7. FIG. 8(b) is an equivalent circuit diagram of the acquisition part. FIG. 9 and FIG. 10 are equivalent circuit diagrams showing modifications of the acquisition part.

As shown in FIG. 7, the input device 1 in the present embodiment includes a touch panel controller 80 to which the touch panel 30 is electrically connected, a sensor controller 90 to which the pressure-sensitive sensors 50 are electrically connected, and a computer 100 to which the controller 80 and controller 90 are electrically connected. The sensor controller 90 in the present embodiment corresponds to an example of a controller of the present invention.

The touch panel controller 80 includes, for example, an electrical circuit or the like including such as a CPU. The touch panel controller 80 periodically applies a predetermined voltage between the first electrode patterns 312 and second electrode patterns 322 of the touch panel 30, detects a position (an X-coordinate value and a Y-coordinate value) of a finger on the touch panel 30 on the basis of a variation in electrostatic capacitance at each intersection between the first electrode patterns 312 and the second electrode patterns 322, and outputs the X and Y coordinate values to the computer 100.

When a value of the electrostatic capacitance becomes a predetermined threshold value or more, the touch panel controller 80 detects that a finger of the operator came into contact with the cover member 20 and sends a touch-on signal to the sensor controller 90 through the computer 100. In contrast, when a value of the electrostatic capacitance becomes less than the predetermined threshold value, the touch panel controller 80 detects that a finger of the operator became untouched from the cover member 20 and sends a touch-off signal to the sensor controller 90 through the computer 100.

When the touch panel controller 80 detects that a finger of the operator approaches the cover member 20 within a predetermined distance (a so-called hover state), the touch panel controller 80 may send a touch-on signal.

Like the touch panel controller 80, the sensor controller 90 includes, for example, an electrical circuit with a CPU or the like. The sensor controller 90 functionally includes, as shown in FIG. 7, acquisition parts 91, storage parts 92, first correction parts 93, setting parts 94, first calculation parts 95, a selection part 96, second correction parts 97, a second calculation part 98, and a sensitivity adjustment part 99. The acquisition part 91 in the present embodiment corresponds to an example of an acquisition part of the present invention, the storage part 92 in the present embodiment corresponds to an example of a storage part of the present invention, and the first correction part 93 in the present embodiment corresponds to a correction part of the present invention.

Each of the acquisition parts 91 includes: as shown in FIG. 8(a) and FIG. 8(b), a power supply 911 which is connected in series to the upper electrode 522 (or the lower electrode 532) of the pressure-sensitive sensor 50; a first fixed resistor 912 which is connected in series to the lower electrode 532 (or the upper electrode 522) of the pressure-sensitive sensor 50; and an A/D converter 915 which is connected between the pressure-sensitive sensor 50 and the first fixed resistor 912. The first fixed resistor 912 in the present embodiment corresponds to an example of a fixed resistor of the present invention.

In a state in which a predetermined voltage is applied between the electrode 522 and electrode 532 by the power supply 911, when a load from the upper side is applied to the pressure-sensitive sensor 50, an electrical resistance value between the electrode 522 and electrode 532 varies in accordance with the magnitude of the load. The acquisition part 91 periodically samples an analog signal of a voltage value, which corresponds to the resistance variation, from the pressure-sensitive sensor 50 at a constant interval, converts the analog signal into a digital signal with an A/D converter 915, and outputs the digital signal (an actual output value) to the first correction part 93.

As shown in FIG. 7, the acquisition part 91 is provided for each pressure-sensitive sensor 50, and obtains an actual output value from each pressure-sensitive sensor 50.

As illustrated in FIG. 9, the acquisition part 91 may include a second fixed resistor 913 which is connected in parallel to the pressure-sensitive sensor 50. As illustrated in FIG. 10, the acquisition part 91 may include a third fixed resistor 914 which is connected in series to a parallel circuit which includes the pressure-sensitive sensor 50 and the second fixed resistor 913. The output characteristics of the pressure-sensitive sensor 50 can be made close to a linear shape by adjusting resistance values of the first fixed resistor 912 to the third fixed resistor 914.

A correction function g(Vₒᵤₜ) for correcting actual output values of the pressure-sensitive sensor 50 to a linear shape is stored in each of the storage parts 92. As described in the following, the correction function g(Vₒᵤₜ) is a function which is obtained by replacing an output variable Vₒᵤₜ of the pressure-sensitive sensor 50 with a corrected output variable Vₒᵤₜ′ of the pressure-sensitive sensor 50 and also replacing an applied-load variable F to the pressure-sensitive sensor 50 with the output variable Vₒᵤₜ in an inverse function f⁻¹(F) of an output characteristic function f(F) of the pressure-sensitive sensor 50. Specifically, in the present embodiment, the correction function g(Vₒᵤₜ) is represented by the following expression (9).

$$\begin{matrix}[ Expression 9 ] & \\ g ( {V}_{out} ) = {V}_{out}^{′} = {\{ \frac{{R}_{fix }}{k} ( \frac{{V}_{in}}{{V}_{out}} - 1 ) \}}^{- \frac{1}{n}} & ( 9 )\end{matrix}$$

In the expression (9) above, R_{fix} is a resistance value of the first fixed resistor 912, Vᵢₙ is an input-voltage value to the pressure-sensitive sensor 50, “k” is an intercept constant of the pressure-sensitive sensor 50, and “n” is an inclination constant of the pressure-sensitive sensor 50.

As shown in FIG. 7, a storage part 92 is provided for each pressure-sensitive sensor 50. The correction function g(Vₒᵤₜ) into which a fitting parameter (specifically, “k” and “n” above) of a corresponding pressure-sensitive sensor 50 is entered is stored in each of the storage parts 92. Such correction function g(Vₒᵤₜ) is individually set for each pressure-sensitive sensor 50 in advance as described in the following.

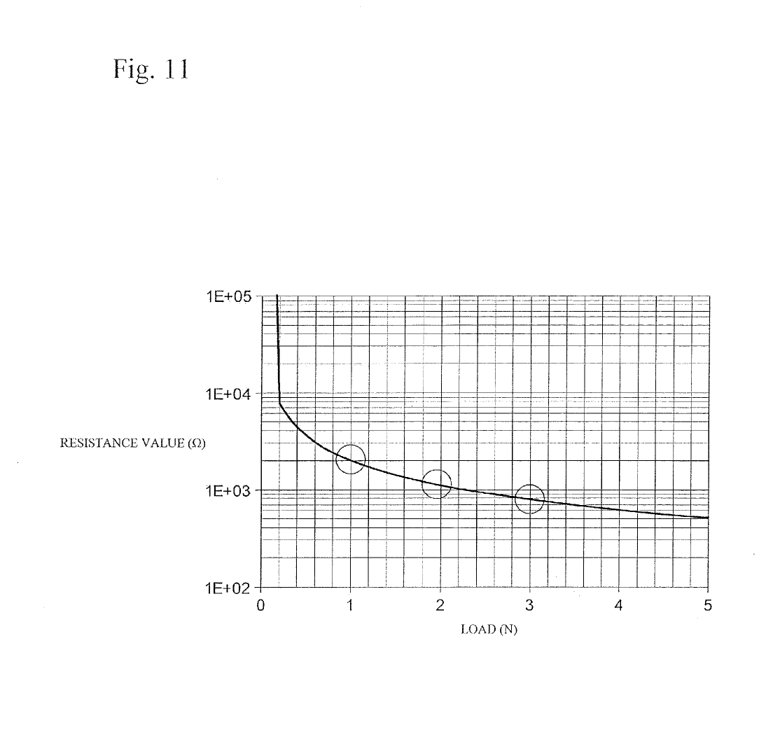

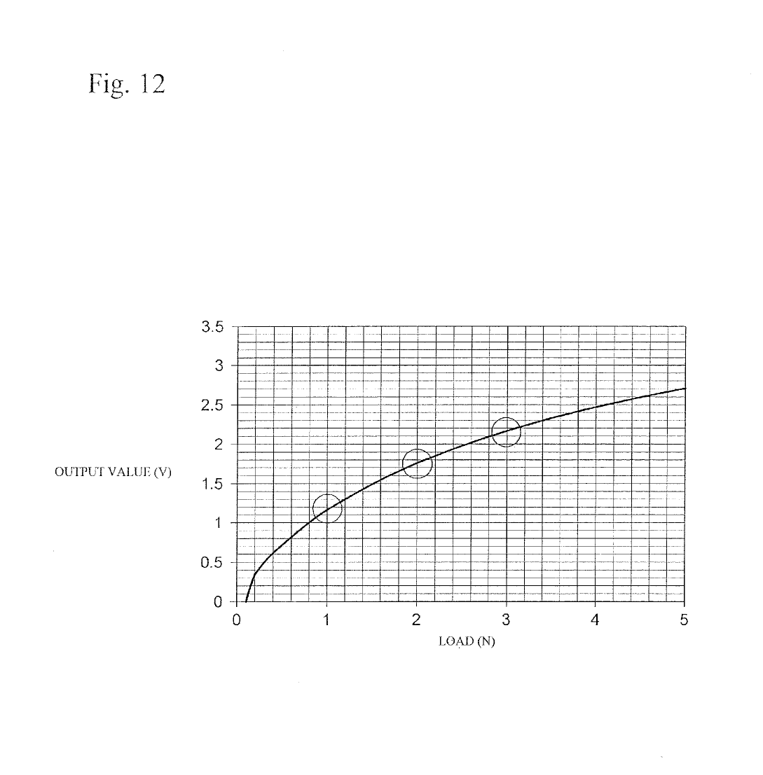

Hereinafter, a method for setting the correction function g(Vₒᵤₜ) is described in detail with reference to FIG. 11 and FIG. 12.

FIG. 11 is a graph showing load-resistance characteristics (a resistance characteristic function h(F)) of a pressure-sensitive sensor in the present embodiment. FIG. 12 is a graph showing load-output voltage characteristics (an output characteristic function f(F)) of the pressure-sensitive sensor in the present embodiment.

First, as shown in FIG. 11, a resistance value of the pressure-sensitive sensor is measured at a plurality of load points (in the present example, three points circled in FIG. 11). Then, an intercept constant “k” and an inclination constant “n” are calculated by performing curve fitting (substituting into a curve) to the following expression (10) using the measured resistance values. The following expression (10) is an empirical expression which represents characteristics of the pressure-sensitive sensor by utilizing pressure dependency of contact resistance. The expression (10) is a resistance characteristic function which shows a relationship between applied-load variable F to the pressure-sensitive sensor 50 and a resistance variable Rₛₑₙₛ of the pressure-sensitive sensor 50, and represents a resistance variable Rₛₑₙₛ with respect to the applied-load variable F.

[Expression 10]

Rₛₑₙₛ=k×F⁻ⁿ (10)

As shown in FIG. 12, an intercept constant “k” and inclination constant “n” may be calculated by measuring output voltage of the pressure-sensitive sensor 50 at a plurality of load points (in the present example, the three points circled in FIG. 12) and performing curve fitting to the following expression (12) using the measured output-voltage values.

The above expression (10) in the present embodiment corresponds to an example of a resistance characteristic function h(F) in the present invention. The resistance characteristic function h(F) is not particularly limited thereto, and for example, an approximation function which utilizes polynomial approximation, logarithmic approximation, power approximation, or the like may also be used.

An output-voltage value of the pressure-sensitive sensor 50 detected using a circuit including a fixed resistor 912 connected in series (refer to FIG. 8) can be expressed with the following expression (11). When the expression (10) is substituted into the following expression (11), the following expression (12) can be obtained. The following expression (12) is an output characteristic function which shows a relationship between an applied-load variable F to the pressure-sensitive sensor 50 and an output variable Vₒᵤₜ of the pressure-sensitive sensor 50, and represents an output variable Vₒᵤₜ with respect to the applied-load variable F.

$$\begin{matrix}[ Expression 11 ] & \\ {V}_{out} = {V}_{in} \frac{{R}_{fix}}{{R}_{fix} + {R}_{sens}} & ( 11 ) \\ [ Expression 12 ] & \\ f ( F ) = {V}_{out} = {V}_{in} \frac{{R}_{fix}}{{R}_{fix} + k \times {F}^{- n}} & ( 12 )\end{matrix}$$

Further, an inverse function f (F) of the above expression (12) for the applied-load variable F and output variable Vₒᵤₜ is calculated so that the following expression (13) is obtained. Then, by replacing the output variable Vₒᵤₜ of the pressure-sensitive sensor 50 with a corrected output variable Vₒᵤₜ′ of the pressure sensitive sensor 50 and also replacing the applied-load variable F to the pressure-sensitive sensor 50 with the output variable Vₒᵤₜ in the expression (13), the correction function g(Vₒᵤₜ) of the above expression (9) can be obtained. In other words, the correction function g(Vₒᵤₜ) of the expression (9) is an expression obtained by solving the above expression (12) for the applied-load variable F by deformation of the expression.

$$\begin{matrix}[ Expression 13 ] & \\ {f}^{- 1} ( F ) = {V}_{out} = {\{ \frac{{R}_{fix }}{k} ( \frac{{V}_{in}}{F} - 1 ) \}}^{- \frac{1}{n}} & ( 13 )\end{matrix}$$

A process of preparing the correction function g(Vₒᵤₜ) of the expression (9) as above corresponds to an example of a first step in the present invention.

A resistance value of the second fixed resistor 913 shown in FIG. 9 is sufficiently larger than a resistance value Rₛₑₙₛ of the pressure-sensitive sensor 50. Accordingly, even when an acquisition part 91 has a circuit configuration shown in FIG. 9, the second fixed resistor 913 can be ignored, and the above expression (12) can be used as it is.

Alternatively, for an example shown in FIG. 9, the following expression (14) can be used as a correction function g(Vₒᵤₜ). In the expression (14), R₂ is a resistance value of the second fixed resistor 913.

$$\begin{matrix}[ Expression 14 ] & \\ g ( {V}_{out} ) = {V}_{out}^{′} = {\{ \frac{1}{k} \times \frac{1}{\frac{1}{{R}_{fix}} \times \frac{1}{\frac{{V}_{in}}{{V}_{out}} - 1} - \frac{1}{{R}_{2}}} \}}^{- \frac{1}{n}} & ( 14 )\end{matrix}$$

Here, an output-voltage value of the pressure-sensitive sensor 50 detected by utilizing an acquisition part 91 of a configuration shown in FIG. 9, can be expressed with the following expression (15). In other words, when the acquisition part 91 includes a second fixed resistor as in an example shown in FIG. 9, the resistance variable Rₛₑₙₛ in the expression (11) only needs to be replaced with a combined resistance of a parallel circuit including the pressure-sensitive sensor 50 and the second fixed resistor.

$$\begin{matrix}[ Expression 15 ] & \\ f ( F ) = {V}_{out} = {V}_{in} \frac{{R}_{fix}}{{R}_{fix} \times \frac{1}{\frac{1}{{R}_{2}} + \frac{1}{k \times {F}^{- n}}}} & ( 15 )\end{matrix}$$

The above expression (14) is a function which is obtained by replacing an output variable Vₒᵤₜ of the pressure-sensitive sensor 50 with a corrected output variable Vₒᵤₜ′ and also replacing an applied-load variable F to the pressure-sensitive sensor 50 with the output variable Vₒᵤₜ in an inverse function f⁻¹(F) of an output characteristic function f(F) in the expression (15). The inverse function f⁻¹(F) of the output characteristic function f(F) of the expression (15) can be expressed with the following expression (16).

$$\begin{matrix}[ Expression 16 ] & \\ {f}^{- 1} ( F ) = {V}_{out} = {\{ \frac{1}{k} \times \frac{1}{\frac{1}{{R}_{fix}} \times \frac{1}{\frac{{V}_{in}}{F} - 1} - \frac{1}{{R}_{2}}} \}}^{- \frac{1}{n}} & ( 16 )\end{matrix}$$

When the acquisition part 91 includes a circuit configuration shown in FIG. 10, as with the example shown in FIG. 9 above, the resistance variable Rₛₑₙₛ in the expression (11) only needs to be replaced with a combined resistance of a parallel circuit which includes a pressure-sensitive sensor 50 and a second fixed resistor 913 and a third fixed resistor 924 which is connected in series to the parallel circuit.

Although not shown in the drawings, even when another fixed resistor is electrically connected to the first fixed resistor 912, the resistance value R_{fix} in the expression (11) only needs to be replaced with their combined resistance.

Return to FIG. 7, each of the first correction parts 93 substitutes the actual output value obtained by the acquisition part 91 into the output variable Vₒᵤₜ in the correction function g(Vₒᵤₜ) of the expression (9). [0127] Here, in the expression (9), a resistance value R_{fix} of the first fixed resistor 912 and an input-voltage value Vᵢₙ to the pressure-sensitive sensor 50 (that is, the voltage Vᵢₙ of the power supply 911) are already known, and an intercept constant “k” and an inclination constant “n” are decided as mentioned above. The values R_{fix}, Vᵢₙ, “k”, and “n” are stored in the storage part 92 and are entered into the correction function g(Vₒᵤₜ). Accordingly, by substituting an actual output value into the output variable Vₒᵤₜ in the correction function g(Vₒᵤₜ), the first correction part 93 can uniquely obtain an output value after correction OP (=Vₒᵤₜ′).

As shown in FIG. 7, the first correction part 93 is provided for each pressure-sensitive sensor 50 as with the acquisition part 91 and the storage part 92, and calculates a corrected output value OPₙ for each pressure-sensitive sensor 50.

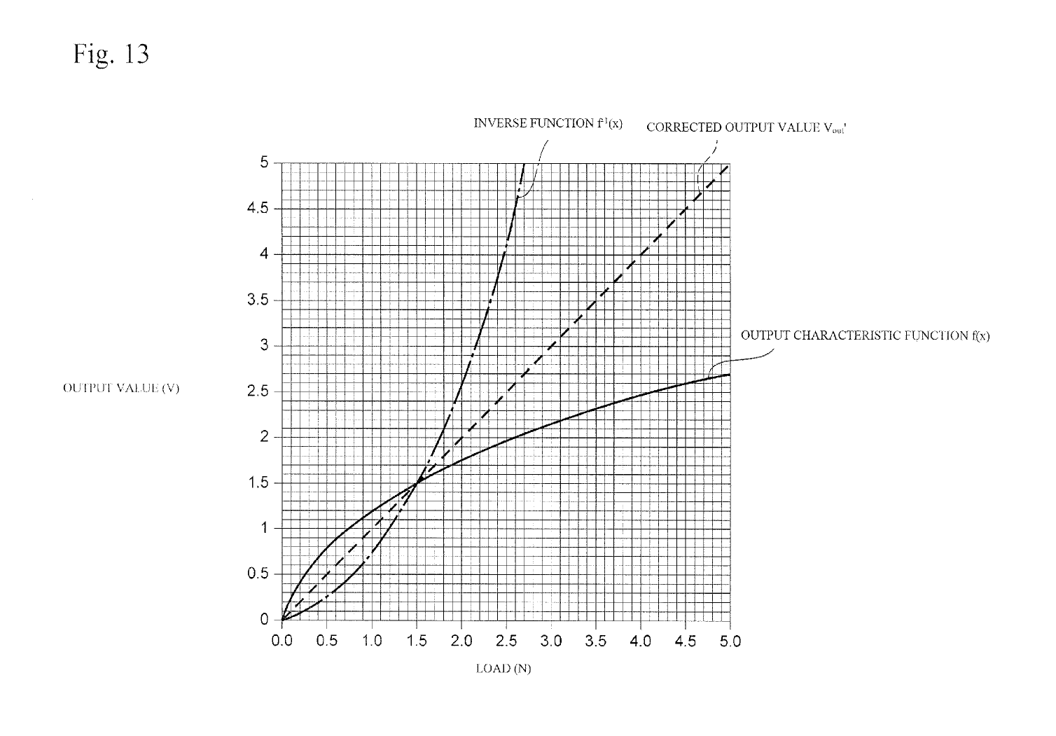

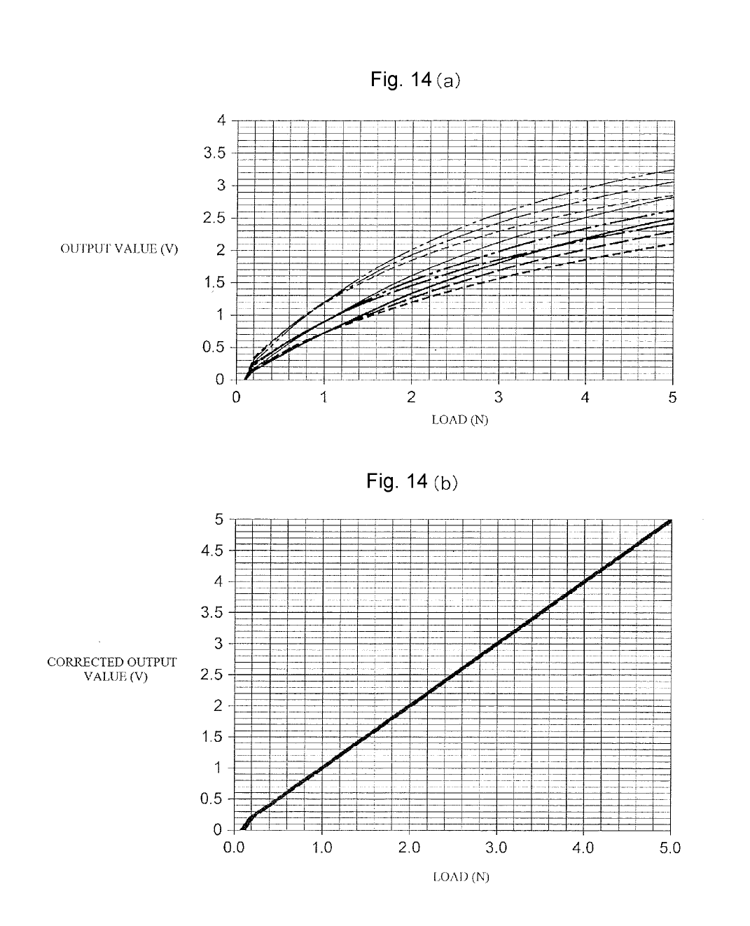

FIG. 13 is a graph showing an output characteristic function f(F), an inverse function f⁻¹(F), and corrected output values derived from a correction function g(Vₒᵤₜ) of the pressure-sensitive sensor in the present embodiment. FIG. 14(a) is a graph showing output characteristics of pressure-sensitive sensors before correction, and FIG. 14(b) is a graph showing output characteristics of the pressure-sensitive sensors after correction.

Here, as shown in FIG. 13, a composite function of the output characteristic function f(F) and the inverse function f⁻¹(F) becomes an identity function, which can be expressed by the following expression (17), by definition of an inverse function.

[Expression 17]

ƒ·ƒ⁻¹(x)=x (17)

Accordingly, when actual output values of the pressure-sensitive sensor 50 are substituted into the output value Vₒᵤₜ in the expression (9), even when the actual output values with respect to the applied load exhibit a curve, the actual output values can be brought closer to a straight line of the identity function (that is, y=x). In FIG. 13, a solid line represents the output characteristic function f(F) of the above expression (12), and a one-dotted chain line represents the inverse function f⁻¹(F) of the above expression (13), and a broken line represents values which is obtained by correcting the output values of the output characteristic function f(F) with the correction function g(Vₒᵤₜ)

When there are variations in the actual output values of the pressure-sensitive sensors 50 before correction (refer to FIG. 14(a)), as the correction function g(Vₒᵤₜ) is generated for each pressure-sensitive sensor 50 in the present embodiment, such variations can be suppressed (refer to FIG. 14(b)) by substituting the actual output values into the above expression (9).

FIG. 14(a) represents nine output characteristic functions f(F) intentionally made to vary. For these nine output characteristic functions f(F), an applied voltage Vᵢₙ to the pressure-sensitive sensor 50B by the power supply 911 in a circuit shown in FIG. 8 is set to 5V, a resistance value of the first fixed resistor 912 in the circuit shown in the figure is set to 2200Ω, three constants, 7000, 10000, and 13000, are for the intercept constant “k”, and three constants, 0.9, 1.0, and 1.1, are set for the inclination constant “n”.

In contrast, FIG. 14(b) is a graph showing the results obtained by substituting corresponding theoretical output values (refer to FIG. 14(a)) into each of the nine types of expressions (13) generated using the three types of intercept constants “k” and three types of inclination constants “n”.

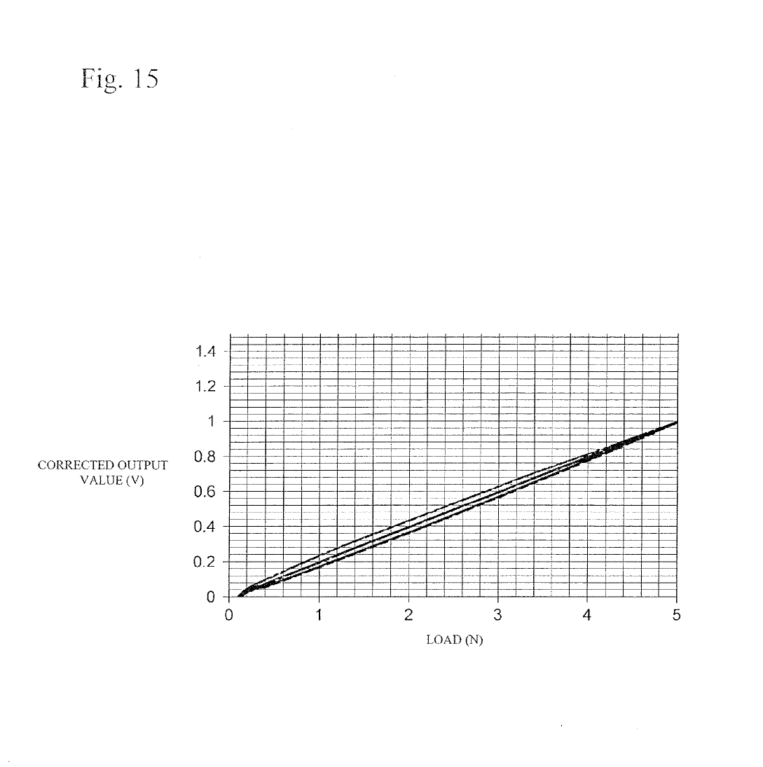

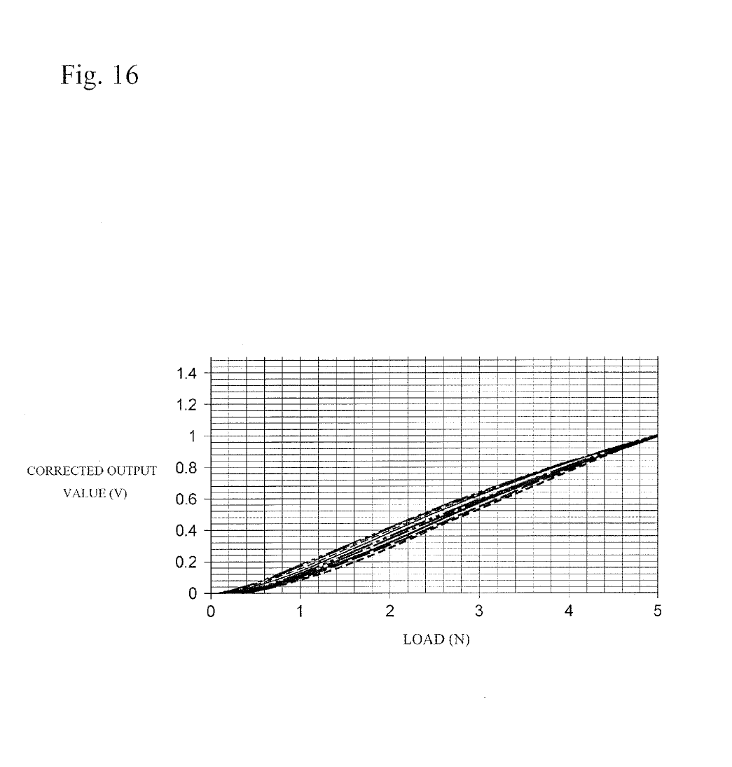

FIG. 15 represents output characteristics of the pressure-sensitive sensors after correction with a first approximate function, and FIG. 16 is a graph showing output characteristics of the pressure-sensitive sensors after correction with a second approximate function.

Instead of the correction function g(Vₒᵤₜ) shown in the expression (9), a first approximate function g(Vₒᵤₜ) shown in the following expression (18) may be stored in the storage part 92, and further, the first correction part 93 may correct the actual output values using the first approximate function g(Vₒᵤₜ).

$$\begin{matrix}[ Expression 18 ] & \\ g ( {V}_{out} ) = {V}_{out}^{′} = {k}^{′} \frac{{V}_{out}}{{V}_{in} - {V}_{out}} & ( 18 )\end{matrix}$$

The above expression (18) is an expression which is obtained by making n=1 in the expression (9), and k′ is expressed by the following expression (19). The value of k′ is set, for example, so as to make a corrected output value Vₒᵤₜ′ “1” when the maximum load is applied (5N is applied in an example shown in FIG. 15). Here, the “n” is set to “1” (n=1) because the inclination constant “n” of the pressure-sensitive sensor 50 usually is around 1.0.

$$\begin{matrix}[ Expression 19 ] & \\ {k}^{′} = \frac{k}{{R}_{fix}} & ( 19 )\end{matrix}$$

As above, when a simplified expression shown in the expression (18) is used instead of the correction function g(Vₒᵤₜ), although linearity of the corrected output values Vₒᵤₜ′ is slightly lost as shown in FIG. 15, processing speed of the sensor controller 80 can be improved, it is possible to deal with a sensor controller of a low processing speed. s

FIG. 15 is a graph showing the results obtained by substituting corresponding theoretical output values (refer to FIG. 14(a)) into each of the nine types of expressions (18) generated using the three types of intercept constants “k” and three types of inclination constants “n”.

Instead of the correction function g(Vₒᵤₜ) shown in the expression (9), a second approximate function g(Vₒᵤₜ) shown in the following expression (20) may be stored in the storage part 92, and further, the first correction part 93 may correct the actual output values using the second approximate function g(Vₒᵤₜ).

[Expression 20]

g(Vₒᵤₜ)=Vₒᵤₜ′=a×Vₒᵤₜ² (20)

The above expression (20) is based on that a shape of the inverse function f⁻¹(F) shown in FIG. 13 resembles the shape of the following expression (21). In the expression (20), “a” is a proportional constant and, for example, is set so as to make the corrected output value Vₒᵤₜ′ “1” when the maximum load is applied (5N is applied in an example shown in FIG. 16).

[Expression 21]

y=ax² (21)

As above, when a simplified expression shown in the expression (20) is used instead of the correction function g(Vₒᵤₜ), although linearity of the corrected output values Vₒᵤₜ′ is slightly lost as shown in FIG. 16, processing speed of the sensor controller 80 can be further improved, and it is possible to deal with a sensor controller of a low processing speed.

FIG. 16 is a graph showing the results obtained by substituting corresponding theoretical output values (refer to FIG. 14(a)) into each of the nine types of expressions (20) generated using the three types of intercept constants “k” and three types of inclination constants “n”.

An approximate function which can be used instead of the correction function g(Vₒᵤₜ) is not particularly limited to the first approximate function and the second approximate function above, and for example, an approximate expression which utilizes second or lower degree polynomial approximation, logarithmic approximation, power approximation, or the like may be used.

Return to FIG. 7, when a touch-on signal is input from a touch panel controller 80 through a computer 100, the setting part 94 of the sensor controller 80 sets, as a reference value OP₀, a corrected output value OPₙ of an actual output value of the pressure-sensitive sensor 50 at the time of or immediately before the detection of the contacting (that is, an actual output value sampled at the time of or immediately before the detection of the contacting). The setting part 94 is provided for each pressure-sensitive sensor 50 and sets the reference value OP₀ for each pressure-sensitive sensor 50.

The reference value OP₀ also includes zero (0). When the touch-on signal indicates that approaching of the finger to the cover member 20 within a predetermined distance is detected, the setting part 94 sets, as the reference value OP₀, a corrected output value OPₙ of an output value of the pressure-sensitive sensor 50 at the time of or immediately after the detection of the approaching (that is, an output value sampled at the time of or immediately after the detection of the approaching).

The first calculation part 95 calculates a first pressing force pₙ₁ applied to the pressure-sensitive sensor 50 in accordance with the following expression (22). As shown in FIG. 7, as with the acquisition part 91, the storage part 92, the first correction part 93, and the first setting part 94 above, the first calculation part 95 is also provided to each pressure-sensitive sensor 50, and calculates the first pressure force pₙ₁ for each pressure-sensitive sensor 50.

[Expression 22]

pₙ₁=OPₙ−OP₀ (22)

The selection part 96 selects the minimum value among four reference values OP₀ which are set by the four setting parts 94, and sets, as a comparison value S₀, the minimum reference value.

The second correction part 97 calculates a correction value Rₙ of each pressure-sensitive sensor 50 in accordance with the following expression (23) and expression (24), and corrects the first pressing force pₙ₁ of the pressure-sensitive sensor 50 by using the correction value Rₙ. As is the case with the acquisition part 91, setting part 92, the first correction part 93, the setting part 94, and the first calculation part 95, the second correction part 96 is also provided for each pressure-sensitive sensor 50 as shown in FIG. 7, and corrects the first pressing force pₙ₁ for each pressure-sensitive sensor 50. In the following expression (24), pₙ₁′ represents a first pressing force after correction.

$$\begin{matrix}[ Expression 23 ] & \\ {R}_{n} = \frac{{OP}_{0}}{{S}_{0}} & ( 23 ) \\ [ Expression 24 ] & \\ {p}_{n 1}^{′} = {p}_{n 1} \times {R}_{n} & ( 24 )\end{matrix}$$

As above, the pressure-sensitive sensor 50 has characteristics in a form of a curve where a rate of decrease in resistance values is duller as an applied load is larger. Accordingly, even when load-variation amounts are the same, a phenomenon that resistance variation amounts are different from each other depending on an initial load occurs. Particularly, a different initial load may be applied to the four pressure-sensitive sensors 50 provided to the input device 1 due to the posture of the input device 1, and the like. Accordingly, the first pressing force pₙ₁, which is calculated by the first calculation part 95 greatly depends on the initial load of each pressure-sensitive sensor 50.

In contrast, in the present embodiment, since the first pressing force pₙ₁ is corrected by using the correction value Rₙ to reduce an effect of the initial load with respect to the first pressing force pₙ₁, it is possible to improve detection accuracy of the pressure-sensitive sensor 50.

As long as the selection part 96 selects any one value among reference values OP₀ as a comparison value S₀, the selection part 96 may select, for example, a maximum value among the reference values OP₀ as the comparison value S₀.

A method for correcting the first pressing force pₙ₁ by the selection part 96 is not particularly limited to the above-described method as long as the further the reference value OP₀ is greater than the comparison value S₀, the larger the first pressing force pₙ₁ is corrected, and the further the reference value OP₀ is smaller than the comparison value S₀, the smaller the first pressing force pₙ₁ is corrected.

The second calculation part 98 calculates, as a second pressing force pₙ₂ which is applied to the cover member 20, the sum of first pressing forces pₙ₁′ of the four pressure-sensitive sensors 50 after correction in accordance with the following expression (25).

[Expression 25]

pₙ₂=Σpₙ₁′ (25)

A sensitivity adjustment part 99 performs sensitivity adjustment for the second pressing force pₙ₂ in accordance with the following expression (26) to calculate a final pressing force Pₙ. The pressing force Pₙ calculated with the expression (26) is output to the computer 100. In the following expression (26), k_{adj} represents a coefficient for adjustment of an individual pressure difference of the operator, which is stored in advance, for example, in a sensitivity adjustment part 99, and can be accordingly set depending on the operator.

$$\begin{matrix}[ Expression 26 ] & \\ {P}_{n} = \frac{{p}_{n 2}}{{k}_{adj}} & ( 26 )\end{matrix}$$

Although not particularly illustrated in the drawings, a selector may be interposed between the four pressure-sensitive sensors 50 and the sensor controller 90. In this case, the sensor controller 90 is only required to include each one of an acquisition part 91, a storage part 92, a first correction part 93, a setting part 94, a first calculation part 95, and a second correction part 97.

The computer 100 is an electronic calculator including, although not particularly illustrated in the drawings, a CPU, a main storage device (RAM or the like), an auxiliary storage device (a hard disk, SSD, or the like), and an interface, etc. As shown in FIG. 7, the touch panel controller 80 and sensor controller 90 are electrically connected to the computer 100 through an interface. The computer 100, although not illustrated in the drawings, determines an input operation intended by the operator on the basis of a position of the finger which is detected by the touch panel controller 80 and the pressing force Pₙ which is detected by the sensor controller 90 by executing various types of programs stored in the auxiliary storage device.

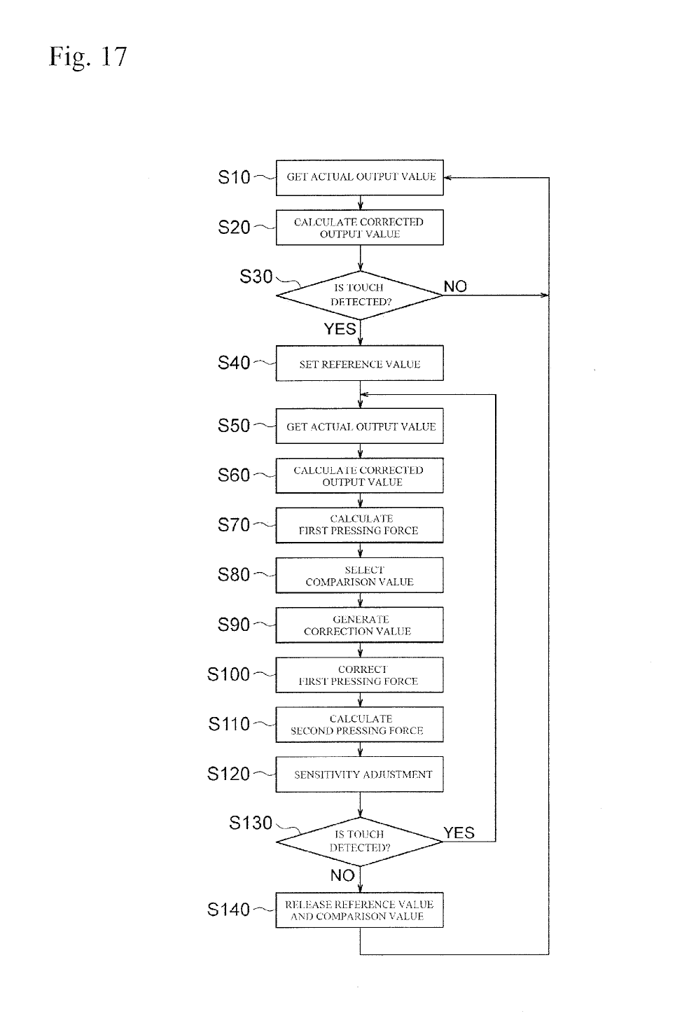

Hereinafter, a method for controlling the input device in the present embodiment is described with reference to FIG. 17. FIG. 17 is a flowchart illustrating the method for controlling the input device in the present embodiment.

When control of the input device 1 in the present embodiment is initiated, first, in step S10 of FIG. 17, the acquisition parts 91 obtain the actual output values from the four pressure-sensitive sensors 50. The actual output value is obtained from each of the pressure-sensitive sensors 50.

Then, in step S20 of FIG. 17, each of the first correction parts 93 corrects the actual output value using a correction function g(Vₒᵤₜ) to calculate a corrected output value OP, and outputs the corrected output value OP to the setting part 94 and the first calculation part 95. The corrected output value OP is also calculated for each pressure-sensitive sensor 50.

Next, in step S30 of FIG. 17, each of the setting parts 94 determines whether or not there is an input of a touch-on signal from the touch panel controller 80.

As long as contacting of a finger of the operator with the cover member 20 is not detected by the touch panel controller 80 (NO in step S30 of FIG. 17), step S10 to step S30 are repeated.

On the other hand, when the contacting of the finger is detected by the touch panel controller 80 (YES in step S30 of FIG. 17), in step S40 of FIG. 17, the setting part 94 sets, as a reference value OP₀, a corrected output value OP of the actual output value which is sampled immediately before the detection of the contacting. The reference value OP₀ is set for each pressure-sensitive sensor 50, and thus four reference values OP₀ are set in the present embodiment.

When the reference values OP₀ are set, the acquisition part 91 obtains an actual output value of the pressure-sensitive sensor 50 again in step S50 of FIG. 17. The actual output value is obtained from each pressure-sensitive sensor 50.

Then, in step S60 of FIG. 17, the first correction part 93 corrects the actual output value obtained in step S50 above using the correction function g(Vₒᵤₜ) to calculate a corrected output value OPₙ. The corrected output value OPₙ is calculated for each pressure-sensitive sensor 50.

Next, in step S70 of FIG. 17, the first calculation part 95 calculates a first pressing force pₙ₁ from the corrected output value OP and the reference value OP₀ in accordance with the expression (22) above. The first pressing force pₙ₁ is also calculated for each pressure-sensitive sensor 50.

Next, in step S80 of FIG. 17, the selection part 96 sets, as a comparison value S₀, the smallest value among the four reference values OP₀.

Then, in step S90 of FIG. 17, the second correction part 97 calculates a correction value Rₙ of each pressure-sensitive sensor 50 in accordance with the expression (23) above. Next, in step S100 of FIG. 17, the second correction part 97 corrects the first pressing force pₙ₁ using the correction value Rₙ in accordance with the expression (24) above. The correction value Rₙ is also calculated for each pressure-sensitive sensor 50.

Following this, in step S110 of FIG. 17, the second calculation part 98 calculates the sum of the first pressing force after correction p′ₙ₁ of the four pressure-sensitive sensors 50 in accordance with the above expression (25) to determine a second pressing force pₙ₂.

Next, in step S120 of FIG. 17, the sensitivity adjustment part 99 performs sensitivity adjustment of the second pressing force Pₙ₂ in accordance with the above expression (26). The second pressing force after the adjustment Pₙ is output to the computer 100. Then, the computer 100 determines an input operation, which is performed by the operator to the input device 1, on the basis of the second pressing force after the adjustment Pₙ. Step S100 may be omitted, and the second pressing force Pₙ₂ which is calculated in step S110 is output to the computer 100 in this case.

As long as the contacting of the finger continues (YES in step S130 of FIG. 17), processing of the above-described steps S50 to S120 are periodically executed. Step S80 is required only for the first time after the touch-on signal is input from the touch panel controller 80.

In contrast, when the contact of the finger is not detected by the touch panel controller 80 (NO in step S120 of FIG. 17), the settings of the four reference values OP₀ and the comparison value S₀ are released in step S140 of FIG. 17, and the process returns to step S10 of FIG. 17.

As above, in the present embodiment, the actual output value is corrected by substituting the actual output value into the correction function g(Vₒᵤₜ) which is obtained by replacing an output variable Vₒᵤₜ with a corrected output variable Vₒᵤₜ′ and also replacing an applied-load variable F with an output variable Vₒᵤₜ in an inverse function f⁻¹(F) of an output characteristic function f(F) of the pressure-sensitive sensor. In this way, output characteristics of a pressure-sensitive sensor 50 can be linearized, and thus detection accuracy of the pressure-sensitive sensor 50 can be improved.

Step S10 and step S50 of FIG. 17 in the present embodiment correspond to an example of a second step of the present invention, and step S20 and step S60 in FIG. 17 in the present embodiment correspond to an example of a third step of the present invention.

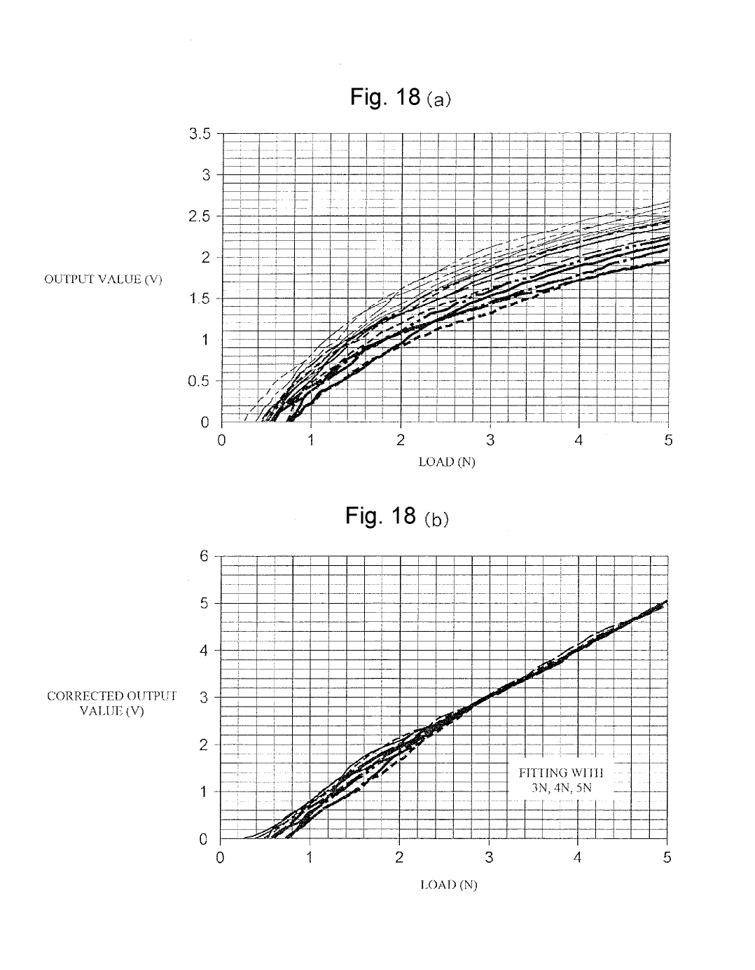

Hereinafter, advantageous effects of the present embodiment are described in detail with reference to FIG. 18(a) and FIG. 18(b).

FIG. 18(a) and FIG. 18(b) are graphs to explain advantageous effects in detail in the present embodiment. FIG. 18(a) shows output characteristics of pressure-sensitive sensors before correction, and FIG. 18(b) shows the output characteristics of the pressure-sensitive sensors after correction.

FIG. 18(a) is a graph created by obtaining actual output values of the pressure-sensitive sensors 50B using the acquisition part 91 of the configuration shown in FIG. 8(a).

The pressure-sensitive sensor 50B has a configuration shown in FIG. 5 and specific specification of the pressure-sensitive sensor 50B is as follows.

A PET sheet having a thickness of 100 μm was used as the first base material 521 and second base material 531, the first upper electrode layer 523 and first lower electrode layer 533B were formed by printing and curing silver paste. In contrast, the second upper electrode layer 524B and second lower electrode layer 534B were formed by printing and curing high-resistance pressure-sensitive carbon paste. The thickness of these electrode layers 523, 524B, 533B, and 534B were all 10 μm. The resistivity of the second upper electrode layer 524B and second lower electrode layer 534B was 100 Ω·cm.

The outer diameter of the first upper electrode layer 523 was 6 mm, the outer diameter of the second upper electrode layer 524B was 8 mm, the outer diameter of the first lower electrode layer 533B was 7.5 mm, and the outer diameter of the second lower electrode layer 534B was 8 mm. A double-sided adhesive sheet having a thickness of 10 μm was used as a spacer 54B, and the inner diameter of the through-hole 541 was 7 mm. An elastic member 55 having a thickness of 0.8 mm was attached onto the first base material 521 through an adhesive tape 551 having a thickness of 150 μm.

Detailed specification of the acquisition part 91 is as follows.

The applied voltage value Vᵢₙ to the pressure-sensitive sensor 50B by the power supply 911 of the acquisition part 91 was 5V, and the resistance value R_{fix} of the first fixed resistor 912 was 2200Ω.

Then, an intercept constant “k” and an inclination constant “n” were calculated by performing fitting to the expression (10) using the resistance values obtained by the acquisition part 91 when 3N, 4N, and 5N were applied in FIG. 18(a). Subsequently, the intercept constant “k” and the inclination constant “n” were substituted into the expression (9) to complete the expression (9).

Next, output characteristics of the pressure-sensitive sensors 50B were corrected by substituting a data of FIG. 18(a) into the output variable Vₒᵤₜ in the expression (9) (that is, filtering the data of FIG. 18(a) by the expression (9)). As a result, as shown in FIG. 18(b), variations in output characteristics of the pressure-sensitive sensors 50B were suppressed, and also the output characteristics were converted to a linear shape.

Note that in the above example, three load points were used when calculating the intercept constant “k” and the inclination constant “n”. However, by increasing the number of load points, linearity in the output characteristics of the pressure-sensitive sensor after correction can be further improved.

The above-described embodiment is described for easy understanding of the invention, and is not intended to limit the invention. Accordingly, respective elements, which are disclosed in the above-described embodiment, are intended to include all design modifications or equivalents thereof which pertain to the technical scope of the invention.

For example, in the above embodiment, the actual output value of the pressure-sensitive sensor 50 and the output variable Vₒᵤₜ of the output characteristics function f(F) were described as the voltage value. However, the voltage value is not particularly limited thereto, and for example, a current value may be used as the actual output value of the pressure-sensitive sensor or the output variable of the output characteristic function.

In the above embodiment, the first correction part 93 is arranged just behind the acquisition part 91. However, the position of the first correction part 93 is not particularly limited thereto. The first correction part 93 can be placed at any position as long as the first correction part 93 is in the sensor controller 90.

The panel unit preferably includes at least a touch panel, however, there is no particular limitation thereto. For example, the panel unit may include only a cover member without including a touch panel.

In the above-described embodiment, the pressure-sensitive sensor 50 are disposed at the four corners of the input device 1, but there is no particular limitation thereto. For example, in a case where the pressure-sensitive sensor is constituted by using an electrostatic capacitance type sensor, the pressure-sensitive sensor may include a sheet-shaped electrostatic capacitive sensor and a transparent elastic member which is provided on the electrostatic capacitive sensor, and the pressure-sensitive sensor may be interposed between the touch panel 30 and the display device 40 with the transparent elastic member disposed on a touch panel 30 side. The pressure-sensitive sensor has substantially the same size as the touch panel 30, and is laid on the entirety of the rear surface of the touch panel 30. In the electrostatic capacitive sensor, a plurality of detection regions are divided, and the sensor controller 90 obtains a detection result from each of the detection regions. In this case, since the touch panel 30 and the display device 40 are fixed through the pressure-sensitive sensors, screws 44 for fixing the display device 40 to the first support member 70 are not required (refer to FIG. 2).

### DESCRIPTION OF REFERENCE NUMERALS

1: Input device
10: Panel unit
20: Cover member
30: Touch panel
40: Display device
50, 50B: Pressure-sensitive sensor
51: Detecting part
52, 52B: First electrode sheet
521: First base material
522, 522B: Upper electrode
525: Protruding part
53, 53B: Second substrate
531: Second base material
532, 522B: Lower electrode
54, 54B: Spacer
541: Through-hole
55: Elastic member
551: Gluing agent
60: Seal member
70: First support member
75: Second support member
80: Touch panel controller
90: Sensor controller
91: Acquisition part
92: Storage part
93: First correction part
94: Setting part
95: First calculation part
96: Selection part
97: Second correction part
98: Second calculation part
99: Sensitivity adjustment part
100: Computer

1. An input device comprising: a pressure-sensitive sensor whose output continuously changes in accordance with a pressing force; and a controller to which the pressure-sensitive sensor is electrically connected, wherein
the controller includes:
an acquisition part which obtains an actual output value of the pressure-sensitive sensor;
a storage part in which a correction function g(Vₒᵤₜ) is stored; and
a correction part which substitutes the actual output value into the correction function g(Vₒᵤₜ) so as to correct the actual output value for linearizing an output characteristic of the pressure-sensitive sensor,
the correction function g(Vₒᵤₜ) is a first function or a second function which is approximate to the first function,
the first function is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor,
the output characteristic function f(F) is a function which represents a relationship between the applied-load variable F and the output variable Vₒᵤₜ of the pressure-sensitive sensor, and
the inverse function f⁻¹(F) is an inverse function of the output characteristic function f(F) for the applied-load variable F and the output variable Vₒᵤₜ.

2. The input device according to claim 1, wherein
a resistance value of the pressure-sensitive sensor continuously changes in accordance with the pressing force.

3. The input device according to claim 2, wherein
the acquisition part includes a fixed resistor which is electrically connected in series to the pressure-sensitive sensor, and
the output characteristic function f(F) is the following expression (1).
$$\begin{matrix}[ Expression 1 ] & \\ f ( F ) = {V}_{out} = {V}_{in} \frac{{R}_{fix}}{{R}_{fix} + h ( F )} & ( 1 )\end{matrix}$$
where, in the expression (1),
Vᵢₙ is an input-voltage value to the pressure-sensitive sensor,
R_{fix} is a resistance value of the fixed resistor, and
h(F) is a resistance characteristic function which represents a relationship between the applied-load variable F and the resistance variable of the pressure-sensitive sensor.

4. The input device according to claim 3, wherein
the resistance characteristic function h(F) is a following expression (2), and
the correction function g(Vₒᵤₜ) is a following expression (3).
$$\begin{matrix}[ Expression 2 ] & \\ h ( F ) = k \times {F}^{- n} & ( 2 ) \\ [ Expression 3 ] & \\ g ( {V}_{out} ) = {V}_{out}^{′} = {\{ \frac{{R}_{fix }}{k} ( \frac{{V}_{in}}{{V}_{out}} - 1 ) \}}^{- \frac{1}{n}} & ( 3 )\end{matrix}$$
where, in the expression (2) and expression (3),
“k” is an intercept constant of the pressure-sensitive sensor, and
“n” is an inclination constant of the pressure-sensitive sensor.

5. The input device according to claim 4, wherein
“n” is equal to 1 (n=1) in an expression (3).

6. (canceled)

7. The input device according to claim 1, wherein
the correction function g(Vₒᵤₜ) is a following expression (4).
[Expression 4]
g(Vₒᵤₜ)=Vₒᵤₜ′=a×Vₒᵤₜ² (4)
where, in the expression (4), “a” is a proportional constant of the pressure-sensitive sensor.

8. The input device according to claim 1, comprising a plurality of pressure-sensitive sensors each of which is the pressure-sensitive sensor, wherein
a plurality of correction functions g(Vₒᵤₜ) each of which is the correction function g(Vₒᵤₜ) are respectively stored in storage part each of which is the storage part, and
the correction functions g(Vₒᵤₜ) individually correspond to the pressure-sensitive sensors.

9. The input device according to claim 1 further comprising a panel unit which includes at least a touch panel, wherein
the pressure-sensitive sensor detects a load applied through the panel unit.

10. A method for controlling an input device including a pressure-sensitive sensor whose output continuously changes in accordance with a pressing force, the method comprising:
(a) preparing a correction function g(Vₒᵤₜ);
(b) obtaining an actual output value of the pressure-sensitive sensor; and
(c) substituting the actual output value into the correction function g(Vₒᵤₜ) so as to correct the actual output value for linearizing an output characteristic of the pressure-sensitive sensor, wherein
the correction function g(Vₒᵤₜ) is a first function or a second function which is approximate to the first function,
the first function which is obtained by replacing an output variable Vₒᵤₜ of the pressure-sensitive sensor with a corrected output variable Vₒᵤₜ′ of the pressure-sensitive sensor and also replacing an applied-load variable F to the pressure-sensitive sensor with the output variable Vₒᵤₜ in an inverse function f⁻¹(F) of an output characteristic function f(F) of the pressure-sensitive sensor,
the output characteristic function f(F) is a function which represents a relationship between the applied-load variable F and the output variable Vₒᵤₜ of the pressure-sensitive sensor, and
the inverse function f⁻¹(F) is an inverse function of the output characteristic function f(F) for the applied-load variable F and the output variable Vₒᵤₜ.

11. The method for controlling the input device according to claim 10, wherein
a resistance value of the pressure-sensitive sensor continuously changes in accordance with the pressing force.

12. The method for controlling the input device according to claim 11, wherein
the input device includes a fixed resistor which is electrically connected in series to the pressure-sensitive sensor, and
the output characteristic function f(F) is the following expression (5).
$$\begin{matrix}[ Expression 5 ] & \\ f ( F ) = {V}_{out} = {V}_{in} \frac{{R}_{fix}}{{R}_{fix} + h ( F )} & ( 5 )\end{matrix}$$
where, in the expression (5),
Vᵢₙ is an input-voltage value to the pressure-sensitive sensor,
R_{fix} is a resistance value of the fixed resistor, and
h(F) is a resistance characteristic function which represents a relationship between the applied-load variable F and a resistance variable of the pressure-sensitive sensor.

13. The method for controlling the input device according to claim 12, wherein
the resistance characteristic function h(F) is a following expression (6), and
the correction function g(Vₒᵤₜ) is a following expression (7).
$$\begin{matrix}[ Expression 6 ] & \\ h ( F ) = k \times {F}^{- n} & ( 6 ) \\ [ Expression 7 ] & \\ g ( {V}_{out} ) = {V}_{out}^{′} = {\{ \frac{{R}_{fix }}{k} ( \frac{{V}_{in}}{{V}_{out}} - 1 ) \}}^{- \frac{1}{n}} & ( 7 )\end{matrix}$$
where, in the expression (6) and expression (7),
“k” is an intercept constant of the pressure-sensitive sensor, and
“n” is an inclination constant of the pressure-sensitive sensor.

14. The input device for controlling the input device according to claim 13, wherein
“n” is equal to 1 (n=1) in an expression (7).

15. (canceled)

16. The method for controlling the input device according to claim 10, wherein
the correction function g(Vₒᵤₜ) is a following expression (8).
[Expression 8]
g(Vₒᵤₜ)=Vₒᵤₜ′=a×Vₒᵤₜ² (8)
where, in the expression (8), “a” is a proportional constant of the pressure-sensitive sensor.

17. The method for controlling the input device according to claim 10, wherein
the input device includes a plurality of pressure-sensitive sensors each of which is the pressure-sensitive sensor,
the (a) includes preparing a plurality of correction functions g(Vₒᵤₜ) each of which is the correction function g(Vₒᵤₜ), and
the correction functions g(Vₒᵤₜ) individually correspond to the pressure-sensitive sensors.
